(19) United States
(12) Patent Application Publication
(10) Pub. No.: US 2020/0309308 A1
(43) Pub. Date: Oct. 1, 2020

(54) DOUBLE-BLOCK AND BLEED (DBB) LINE-STOPPING TOOL, SEALS THEREFOR, AND METHODS OF LINE ISOLATION

(71) Applicant: EnReach Hot Tap Services Inc., Red Deer (CA)

(72) Inventors: David NABER, Red Deer (CA); Amanjeet DHALIWAL, Edmonton (CA); Alexander SKIBA, Edmonton (CA)

(21) Appl. No.: 16/833,234

(22) Filed: Mar. 27, 2020

Related U.S. Application Data
(60) Provisional application No. 62/824,761, filed on Mar. 27, 2019.

(51) Int. Cl. F16L 55/11

(52) U.S. Cl. CPC F16L 55/1141; F16L 41/04

(57) ABSTRACT

Provided is a double-block and bleed (DBB) line-stopping tool for use in line isolation operations, as well as seals to be used with line-stopping tools and methods of line isolation employing the DBB tool.

### CROSS-REFERENCE TO RELATED APPLICATIONS

This application claims the benefit of U.S. Provisional Application Ser. No. 62/824,761 filed on Mar. 27, 2019, which is incorporated herein by reference in its entirety.

### FIELD

The present invention generally relates to a double-block and bleed (DBB) line-stopping tool for use in line isolation operations, as well as seals to be used with the DBB tool and methods of line isolation employing the DBB tool.

### BACKGROUND

Pipes and other flow lines, such as used in the oil and gas industry, commonly require hot-tapping and line-stopping operations in order to isolate a section of pipe while the pipeline itself remains pressurized.

Hot-tapping, or pressure-tapping, refers to the process of making a connection into a pressurized pipe or vessel using equipment and procedures to ensure that the pressure and fluids are safely contained when access is made. Probably the most common example is tapping into a pressurized oil and gas pipeline. Hot-tapping is often performed by fitting a branch connection (e.g. flanged saddle) to the live pipe, whereby the branch connection is fitted with a temporary valve that prevents leakage from the live fluid pipe after tapping (e.g. drilling) into the pipe. The tapping tool itself is configured to prevent leakage during pipe cutting and upon removal the temporary valve is closed to complete the branch connection. Line-stopping tools may then be inserted into the live pipe through the hot-tap connection to isolate a downstream region of pipe from the pressures and fluids.

The industry currently utilizes hot-tapping and line isolation techniques to perform a variety of tasks, including pipeline maintenance and repairs. The requirements of a line isolation are defined by various safety and regulatory bodies in which operator guidelines are established. For example, according to the Occupational Health and Safety (OHS) Code in Alberta, Canada, in order to isolate piping or a pipeline containing harmful substances under pressure, an operator is required to use either (a) a system of blanking or blinding or (b) a double-block and bleed isolation system (Section 215.4—Isolating piping). Blanking and blinding are methods of providing a physical barrier to the end of a pipe section or into a cross-section of piping. These methods can only be employed when the section of piping is not in-service.

A double-block and bleed (DBB) system is required, on each upstream side of a pipeline, when the pipeline is in-service and there is potential for the flow of the substance to come from more than one direction. This system involves the use of a three-valve setup where a pipe has two block valves (double-block) and an open drain (bleed) valve positioned in between. The closed valves provide a stop in fluid flow, while the bleed valve is used to redirect flow in the event of a valve leak. In situations in which there was no system in place to provide any isolation (e.g. typically DBB valve systems are not in place unless installed during new construction), a DBB line-stopping tool can be used in conjunction with in-service hot-tapping systems to provide temporary isolation of downstream pipe.

A basic single line-stop system mechanically lowers the line-stopping tool head through the hot-tap valve and as the plug enters the pipeline a seal is attained with the pipeline pressure pressing the plug seal against the pipe bore. This basic line-stopping tool system has been adapted with a primary and secondary plug in a single fitting, such as disclosed in U.S. Pat. No. 7,841,364. A bleed valve is then hot-tapped in between the two plugs to attempt a double-block and bleed system. This has been the primary method in which line stops have been performed when a DBB system is required. An example of this system is commonly known as TDW Train or a STOPPLE® system (STOPPLE is a registered trademark of T. D. Williamson Inc., Tulsa, Okla., USA).

Several issues exist with conventional line-stopping systems and methods. For one, a basic system with two plugs and a bleed valve does not meet the full criteria of a DBB isolation system. In such systems, the seals require pipeline pressure to actively engage the wall of the pipe, i.e. to become energized. However, when pipeline pressure is against the first plug creating a seal, there is no pressure in the void between the energized seal and the second downstream seal. Therefore, the second downstream seal is not energized (i.e. not engaged against the wall of the pipe) when the first seal is energized. As such, there is no double-block. In such situations, if the energized seal on the first plug fails, there is a high likelihood of the first plug shifting on angle, thereby affecting the alignment of the second plug and causing improper seal engagement with the pipeline and, ultimately, a line stop failure. Additionally, if there is seepage passed the first seal, this seepage is not enough volume and pressure to energize the second seal and therefore this seepage will get passed the second seal and is considered a non-working line stop or failure.

For another, in typical systems with two plugs such as the STOPPLE® system, additional fittings are required to provide the bleed valve, which need to be hot-tapped to the pipeline in between the two seals and remain thereafter. For another, large fittings with two strand plug heads result in a very large installation foot print and limit installation options. Moreover, the large fittings and plug seal cup design complicates removal of the line stop from the pipeline.

U.S. Pat. No. 9,057, 447 discloses another line-stopping tool in which a single plug is adapted with two compression seal elements. In operation, hydraulic pressure is applied to a cavity within the plug that forces a piston to retract and shift a body portion of the plug to compress both of the seal elements simultaneously causing them to expand radially and engage the pipe.

As with conventional two plug line-isolation tools, single plug systems involving actuator engagement of multiple seals does not meet DBB isolation system requirements. In such systems, the seals are not engaged independently. Rather, a single actuator operates both seals. If the actuator fails, both seals will fail.

Seal design is vital to providing an effective DBB isolation system. Common problems with conventional seals are that they are not adaptable to the shape of the pipe and have difficulty providing a leak-proof seal. Also, there is no way to test if the seals are working after installation into the pipeline, and during operation there is no way to monitor the performance of the seals, adjust the seals independently, or confirm if the secondary plug/seal will hold if the primary plug/seal fails. Moreover, conventional seals are not bidirectional, cannot be pressurized on both sides, and cannot handle high pressures, such as for example pressures above 1400 psi.

U.S. Pat. No. 8,307,856 involves a modified STOPPLE® system with an inflatable seal on each of primary and secondary plugs. No details are provided in respect of the structure of the inflatable seals, other than that they are inflated, in concert or in series, so that they come into contact with and sealingly engage an interior surface of a pipe. Although the inflatable seals might resolve some of the above-noted seal deficiencies (e.g. independent adjustment), certain deficiencies remain and others are likely to arise from an inflatable seal of general design. For example, there are likely to be issues with the strength of an inflatable seal and its engagement against an interior surface of the pipe.

Perhaps most significantly, inflatable seals of a general design are most likely susceptible to floating. By “floating”, it is meant to refer to an inconsistent inflation whereby the seal is inflated towards one side of the pipe more than the other, and this inconsistency may shift during operation, thereby creating a loose seal. Floating can occur for several reasons, but the most probable cause is that inflatable seals will inflate according to a path of least resistance. Therefore, if the line-isolation or line-stopping tool is not perfectly centered or if there is pressure against the tool causing it to align improperly in the pipe, the inflatable seal will inflate predominantly on the side of least resistance, creating a larger gap on that side of the tool than the other. Pipeline pressure will attack the side with the larger gap and there will be an increased likelihood of seal failure. Likewise, with floating seals, the center of the seal may shift from one side to another during operation (e.g. due to inconsistencies in the force applied to the seal because the gap is larger on one side than the other), thereby weakening the strength of the sealing engagement and increasing the likelihood of failure.

Therefore, a need exists for a DBB line-stopping tool that provides greater safety, functionality and compliance with DBB criteria, while at the same time being smaller and more flexible in its operation. More particularly, there exists a need for better and stronger seals for a DBB line-stopping tool.

### SUMMARY

The present disclosure recognizes that there are problems in the current existing technology in respect of line-stopping processes and systems, including DBB technologies and tools. Certain existing technologies, for example, are not of sufficient design and/or construction to meet the full criteria of a DBB isolation system, at least in part due to shortcomings in seal design, which is vital to an effective DBB isolation system.

An advantage of the present disclosure is the provision of seals, line-stopping tools and methods having improved characteristics over existing technologies.

In an embodiment, the present disclosure relates to a seal for a line-stopping tool, the seal comprising: (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring.

In an embodiment, the present disclosure relates to a seal for a line-stopping tool, the seal comprising a ring defining a bore and having a width and a thickness, the ring having one or more holes spanning the width and open to both a first and second side of the ring; at least one channel configured for providing fluid communication between the bore of the ring and an exterior surface of the ring outside the bore; and an expandable material covering at least the exterior surfaces of the ring outside the bore, the expandable material forming a seal ring extending around and outwardly from an outer circumference of the ring.

In an embodiment, the present disclosure relates to a line-stopping tool comprising a seal as disclosed herein.

In an embodiment, the present disclosure relates to a line-stopping tool for plugging a pipe, the line-stopping tool comprising: (a) a head unit configured for location in a section of a pipe, the head unit comprising at least one seal configured to engage the wall of the pipe to plug the section of the pipe, wherein the at least one seal comprises (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring, (b) a carrier unit having a pivotal connection to the head unit; and (c) a fluid conduit in fluid communication with one or more of the at least one channels, and configured for providing an expansion medium to the at least one seal. In an embodiment, the head unit comprises two of the seals.

In an embodiment, the present disclosure relates to a line-stopping tool for plugging a pipe, the line-stopping tool comprising a head unit configured for location in a section of a pipe, the head unit comprising at least one seal configured to engage the wall of the pipe to plug the section of the pipe, wherein the at least one seal comprises: (i) a ring defining a bore and having a width and a thickness, the ring having one or more holes spanning the width and open to both a first and second side of the ring; (ii) at least one channel configured for providing fluid communication between the bore of the ring and an exterior surface of the ring outside the bore; and (iii) an expandable material covering at least the surfaces of the ring outside the bore, the expandable material forming a seal ring extending around and outwardly from an outer circumference of the ring, a carrier unit having a pivotal connection to the head unit; and a fluid conduit in fluid communication with one or more of the at least one channels, and configured for providing an expansion medium to the at least one seal. In an embodiment, the head unit comprises two of the seals.

In an embodiment, the present disclosure relates to methods of isolating a section of a pipe using the seals and line-stopping tools as disclosed herein.

In an embodiment, the present disclosure relates to a method of isolating a section of a pipe, the method comprising the steps of: inserting a head unit into a pipe, the head unit comprising at least one seal configured to engage the wall of the pipe, wherein the at least one seal comprises (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring, and providing an expansion medium to the at least one seal via a fluid conduit in fluid communication with the at least one channel of the at least one seal, to sealingly engage the at least one seal against the pipe and thereby isolate a section of the pipe. In an embodiment, the head unit comprises two of the seals.

In an embodiment, the present disclosure relates to a method of isolating a section of a pipe, the method comprising the steps of: inserting a head unit into a pipe, the head unit comprising at least one seal configured to engage the wall of the pipe, wherein the at least one seal comprises (i) a ring defining a bore and having a width and a thickness, the ring having one or more holes spanning the width and open to both a first and second side of the ring; (ii) at least one channel configured for providing fluid communication between the bore of the ring and an exterior surface of the ring outside the bore; and (iii) an expandable material covering at least the surfaces of the ring outside the bore, the expandable material forming a seal ring extending around and outwardly from an outer circumference of the ring, and providing an expansion medium to the at least one seal via a fluid conduit in fluid communication with the at least one channel of the at least one seal, to sealingly engage the at least one seal against the pipe and thereby isolate a section of the pipe. In an embodiment, the head unit comprises two of the seals.

### BRIEF DESCRIPTION OF THE DRAWINGS

Further advantages, permutations and combinations of the invention will now appear from the above and from the following detailed description of the various particular embodiments of the invention taken together with the accompanying drawings, each of which are intended to be non-limiting, in which:

FIG. 1 is an image of an exemplary seal of the present disclosure that is of incomplete construction, whereby the expandable material is only partially in place in order to show the inner ring, outer ring and bridge members.

FIG. 2 is an image of an exemplary seal of the present disclosure whereby the expandable material is in place surrounding the outer ring.

FIG. 3 is a perspective view of a seal of the present disclosure showing the inner ring, outer ring, bridge members and other components.

FIG. 4 is a cross-sectional view along line A-A of the seal shown in FIG. 3 when the seal is in an inactivated (i.e. non-expanded) state.

FIG. 5 is a cross-sectional view along line A-A of the seal shown in FIG. 3 when the seal is in an activated (i.e. expanded) state.

FIG. 6 is a cross-sectional view along line B-B of the seal shown in FIG. 3, which bisects one of the bridge members at a channel. The seal is in an inactivated (i.e. non-expanded) state.

FIG. 7 is a cross-sectional view along line B-B of the seal shown in FIG. 3, which bisects one of the bridge members at a channel. The seal is in an activated (i.e. expanded) state.

FIG. 8 is a cross-sectional view of a seal of the present disclosure having a shoulder and showing the position of the shoulder in a recess in the head unit of a line-stopping tool when the seal is in an inactivated (i.e. non-expanded) state.

FIG. 9 is a cross-sectional view of a seal of the present disclosure having a shoulder and showing the position of the shoulder in a recess in the head unit of a line-stopping tool when the seal is in an activated (i.e. expanded) state.

FIG. 10 is an image of a line-stopping tool of the present disclosure having a head unit with two seals.

FIG. 11 is an internal view of a line-stopping tool of the present disclosure having a head unit with two seals. The line-stopping tool is positioned within a pipe with the seals activated.

FIG. 12 is a view of the line-stopping tool before it is lowered into an access pipe.

FIG. 13 is a view of the line-stopping tool as it is being lowered through the opening in the wall of the pipe.

FIG. 14 is a view of the line-stopping tool as it begins it transition into the pipe.

FIG. 15 is a view of the line-stopping tool in its sealing position in the pipe, prior to delivery of the expansion medium and therefore with the seals in a retracted position.

FIG. 16 is a view of the line-stopping tool in its sealing position in the pipe, subsequent to delivery of the expansion medium and therefore with the seals in an expanded position.

FIG. 17 is an enlarged view of detail C shown in FIG. 15, showing the positioning of the head assembly in the pipe by the knuckle.

FIG. 18 is a perspective view of an alternate embodiment of a seal of the present disclosure where the dual ring structure is more akin to a single ring in view of the multitude of bridge members forming annular spaces of reduced size.

FIG. 19 is a cross-sectional view along line C-C of the seal shown in FIG. 18, which bisects one of the bridge members at a channel. The seal is in an inactivated (i.e. non-expanded) state.

FIG. 20 is a cross-sectional view along line C-C of the seal shown in FIG. 18, which bisects one of the bridge members at a channel. The seal is in an activated (i.e. expanded) state.

### DETAILED DESCRIPTION

It is an objective of the present disclosure to provide an advantageous line-stopping tool comprising an improved design, seals for use therewith or with other line-stopping tools, and methods of employing the line-stopping tool. More particularly, it is an objective of the present disclosure to provide an improved line-stopping tool that, for example, meets double-block and bleed requirements.

The industry currently utilizes hot-tapping and line isolation techniques to perform a variety of tasks. Whether pipelines are transporting water or a more hazardous fluid or gas (e.g. oil, gasoline, natural gas, waste water, sewage, chemicals, or etc.), the passage of time results in an increased need for maintenance or repair. Sections of pipelines may need to be shut down and isolated for many other reasons as well, such as replacing a section of pipe. It is desirable (and necessary) to have safe and effective tools to isolate sections of pipe. For pipelines containing harmful substances, it is also a requirement of certain regulatory bodies or statutes that operators use either a system of blanking or blinding, or a double-block and bleed (DBB) isolation system.

As discussed elsewhere herein, several issues and/or inefficiencies exist with conventional line-stopping systems and methods, including for example: the need to separately hot-tap in between the two seals of a DBB tool; the lack of engagement of a downstream seal prior to primary seal failure; the incorrect alignment of plugs or seals within the pipeline; the inadequate engagement of seals against the pipeline wall and inability to test for proper sealing engagement; the problematic size and/or complicated design of line-stopping tools; the lack of independent engagement of multiple seals; and the occurrence of ‘floating’ seals.

One advantage of the present disclosure is the provision of seals, line-stopping tools and methods having improved characteristics over existing technologies.

Another advantage of the present disclosure is the provision of a line-stopping tool that provides two independently activated and monitored seals on a single head unit. The seals may be activated individually and are completely independent from each other. Moreover, the pressure and sealing engagement of each of the seals may each be monitored and tested throughout operation. This ensures the safety of any personnel that may need to work downstream of the line-stop location.

Another advantage of the present disclosure is the ability to pressure test the seals after activation to ensure that the equipment is in place and the intended line-isolation is achieved. If for some reason a sealing engagement was not obtained, the present line-stopping tool allows for detection of this fault, deactivation of one or multiple seals and subsequent re-activation of the seals without exiting and re-entering the tool from the pipe, which would cause significant delay. In embodiments disclosed herein, the seals may be continually monitored from above-ground, and even remotely. Likewise, pressure at a bleed/pressurization port between the seals may also be continually monitored and bled, providing a true double-block and bleed (DBB) line-stopping tool.

Another advantage is that the line-stopping tool disclosed herein can be inserted either upstream or downstream of the mainline or access pipe. For one, the seals of the present disclosure are bi-directional in that they do not require pipeline pressure to activate. For another, the tooling for a DBB line-stop remains completely encapsulated within the head unit of the line-stopping tool of the present disclosure, meaning that the installation of other fittings is not required.

A further advantage is that the line-stopping tool of the present disclosure is that it is capable of providing activation and sealingly engagement of the seals completely independent of pipeline pressure. The present seals are not activated by pipeline pressure, and therefore the pressure in the pipeline does not impact the functionality of the present technology. The line-stopping tool can be used, and the seals engaged against the wall of the pipeline, irrespective of whether pipeline pressure is present or not. This is quite advantageous since conventional line-stopping tools, which are incapable of creating a sealing engagement on low pressure systems, may require the pipeline pressure to be increased solely for the purpose of engaging the seals. This takes time and is an undesired step. In contrast, the line-stopping tools of the present disclosure work at low pressure. Since the seals do not need to be reactive to pipeline pressure in order to engage the pipe, this also means that they may be made from stronger materials, reducing the likelihood of failure. Moreover, the seals disclosed herein are capable of sealing engagement even in the face of dents or defects in the wall of the pipe or an out of round pipe.

A further advantage is that the line-stopping tool of the present disclosure is capable of being easily and properly aligned in the pipeline. Typically, the plug or head unit of an isolation tool must be quite a bit smaller than the pipe in order to make it around the 90° turn from the access pipe. The smaller the head unit, the more off-centered the head unit will sit in the pipe. The size of head units has been increased by using rounded corners, but because of the rounded corners the head units are still prone to improper alignment. Embodiments of the line-stopping tool disclosed herein may comprise a knuckle on an arm attached to the head unit. The knuckle functions to align the head unit at a centered, right-angle position in the pipe. For instance, in one aspect, the bottom of the knuckle is in planar relationship with the bottom of a carrier unit that lowers the head unit into the pipe. In this arrangement, the knuckle pushes the head unit up in the pipe to provide a centered, right-angle placement. The knuckle offers significant flexibility in that it can be easily swapped for a knuckle of a different size depending on the size of the pipe and/or wall thickness of the pipe.

A yet further advantage is that the seals of the present disclosure are expandable seals of a unique design that offers beneficial properties, e.g. for chemicals or sour gas (H₂S).

Firstly, the expandable material of the seals can be made from a very strong material. As opposed to common inflatable seals that require flexible materials in order to inflate, the internal construction of the seals disclosed herein allows for harder materials to be used. The double-ring structure provides a beneficial design whereby the expandable material covering the sides of the ring is thinner and more easily expandable than the thicker outer seal ring that engages the pipe. Aiding in this beneficial feature is delivery of the expansion medium to an exterior surface of the outer ring. By this design, the outer seal ring provides a strong and firm seal that can better withstand the pressures within the pipe than an inflatable seal of general design, which will frequently fail under pressure because, among other things, the seal material is not strong enough and may run or fold-over under high pressure.

Secondly, and in relation to the seals being made of a harder material, the seals of the present disclosure are well suited for repeated use. The seals are of sufficient material strength to return to their original shape after expansion, as opposed to seals of conventional design and/or softer material which frequently get deformed beyond a point in which they could be re-used. In an embodiment, the seals disclosed herein may comprise springs that further aid in restoring the spring to its original shape after expansion and provide even higher pressure sealing capabilities.

Thirdly, the design of the seals is beneficial in reducing the chance of ‘floating’. It is a general principle of physics that fluids or gases will follow a path of least resistance during inflation. For seals of general design, if there is a larger gap on one side of the plug than on the other, the seal will preferentially inflate to that side. Thus, the seal will be off-centered in the pipe. This uneven inflation will further accentuate the gap differential around the seal. Moreover, the inflation medium may shift from side-to-side during operation due to pressure differences on each side of the seal, which may also change during pipeline isolation. These characteristics may be referred to as ‘floating’, and when the seal has an uneven gap between the plug and the wall of the pipe, pipeline pressures will attack the side with the larger gap increasing the likelihood of seal failure.

The design of the seals disclosed herein reduces or avoids the phenomenon of ‘floating’ because the expansion medium is delivered to an exterior surface of an outer ring. From here, pressure build up from the expansion medium pushes away and causes the narrow expandable material at the sides of the outer ring to stretch, resulting in an equal outward expansion of the expandable material all the way around the ring. Expansion pressure remains localized around the sides and outer region of the outer ring, while the inner ring holds the seal in place on the core of the head unit at all times, thereby preventing floating because the inner ring is in constant contact with the bore at all times.

Lastly, while not technically a feature of the seals, in certain embodiments the head unit of the line-stopping tools disclosed herein comprise a check valve. In the event of a failure in a fluid conduit that supplies expansion medium to the seals, the check valves positioned within the head unit will maintain the expansion medium within the seals and thereby locking pressure in the seals. This has the potential to prevent catastrophic seal failure and/or provide advance warning to prepare downstream operations and evacuate personnel, if appropriate.

The above advantages allow for the provision of a line-stopping tool that enhances safety and increases efficiency and/or functionality of the tool. The result is a pretested and verified DBB line-stopping tool.

Still other advantages and benefits of the seals, line-stopping tool and methods disclosed herein will become apparent to those skilled in the art upon a reading and understanding of the following detailed description.

It will be understood that reference herein to a “line-stopping tool” is to a system or apparatus that may be used to isolate (e.g. seal off or plug) a section of pipe within a process pipeline. By “process pipeline” it is meant to include any pipe that may be used to carry substances, including in particular any fluid-carrying or gas-carrying pipeline. The process pipeline may be a pipeline carrying any type of fluid, gas or chemical, including without limitation oil, gas, natural gas, ammonia, gasoline, alcohol fuels, water, hazardous materials, hazardous waste, waste water, sewage, chemicals or drainage from households, municipalities, manufacturing plants, or food-processing plants. The reference to “pipe” or “pipeline” includes any tubular structure or construction. The pipe may be above ground, below ground, or undersea, or may be any type of downhole tubing. The line-stopping tool may be installed within a section of pipe at any time, including before the pipeline becomes operational, during operation, or during a period when the pipeline is shutdown.

In an embodiment, the line-stopping tool disclosed herein is a double-block and bleed (DBB) line-isolation tool. By a DBB line-isolation tool, it is meant that the line-stopping tool provides at least two separate and independent seals for isolation of a section of pipe, and between the seals is located a bleed valve to purge pressure, fluid and/or gas if it passes the first seal.

Reference will now be made in detail to exemplary embodiments of the disclosure, wherein numerals refer to like components, examples of which are illustrated in the accompanying drawings that further show exemplary embodiments, without limitation.

### Seal for a Line-Stopping Tool

In an embodiment, the present disclosure relates to an improved seal for a line-stopping tool. The seal may be used in the line-stopping tool of the present disclosure or may be used in other available line-stopping tools or DBB tools. In embodiments where the seals of the present disclosure are used in other line-stopping or DBB tools, it is contemplated that the tools may need to be modified to accommodate the seals of the present disclosure. This could readily be accomplished by the skilled person having regard to the present disclosure. Thus, the present disclosure provides seals for the line-stopping tool herein as well as other available line-stopping and DBB tools.

In an embodiment, the seal of the present disclosure comprises: (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring. In such embodiments, the inner ring holds the expandable material to the bore, eliminating floating.

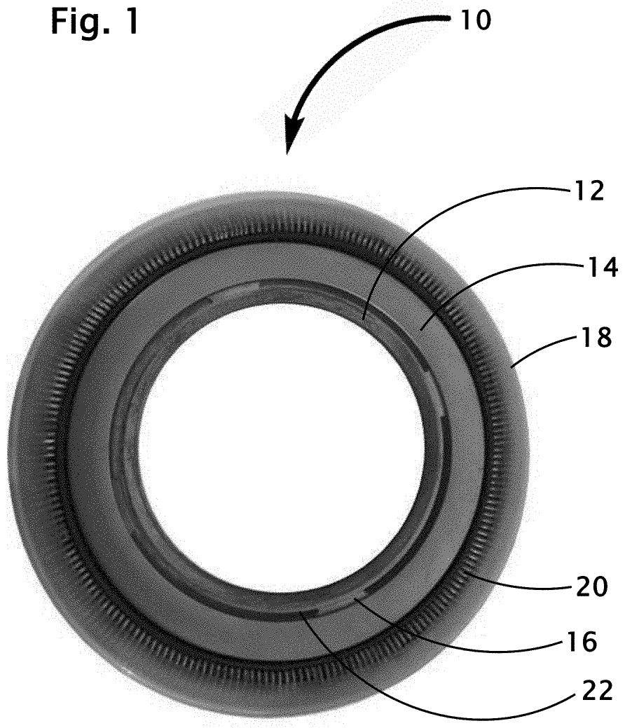

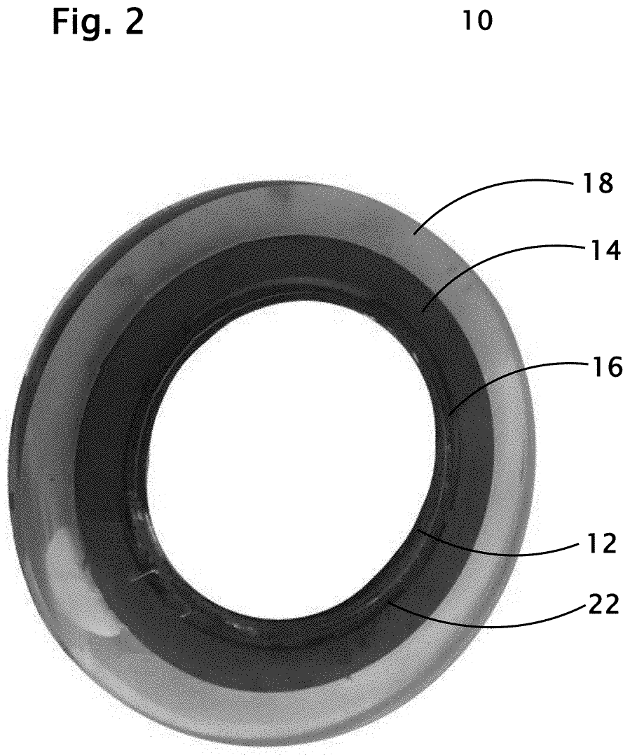

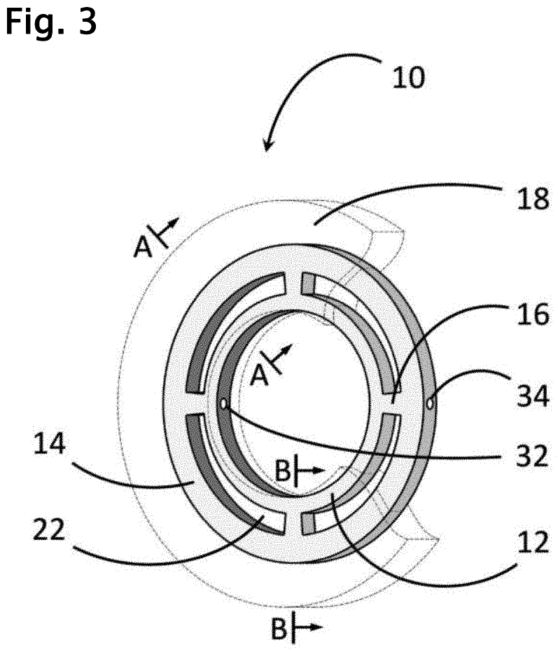

FIGS. 1 and 2 are images of exemplary seals 10 of the present disclosure. In FIG. 1, the expandable material 18 is partially removed to more clearly show the internal structure of the seal 10, including the inner ring 12, outer ring 14, and bridge members 16. The embodiment of FIG. 1 includes a seal spring 20. In FIG. 2, the expandable material 18 is not partially removed, but rather is shown in its functional configuration, surrounding the outer ring 14. The embodiment of FIG. 2 does not include the seal spring 20. FIG. 3 is a drawing of an embodiment of the seals 10 disclosed herein.

Throughout the disclosure herein, the term “ring” has its ordinary meaning in the art in that it is a circular band of material. The inner and outer rings (12 and 14) each comprise a wall defining a bore. It is not necessary that the inner and outer ring (12 and 14) are perfectly circular, and in certain embodiments it is contemplated that a non-circular ring may be advantageous (e.g. where a differential pressure or sealing engagement is desired at different points around the seal). However, in preferred embodiments, the inner and outer ring (12 and 14) are circular.

Throughout the disclosure herein, the surfaces of the inner and outer rings (12 and 14) may be described by the terms outer wall, inner wall, sides, width and thickness. The “width” of a ring herein is a measure of its tubular or longitudinal length (i.e. a length parallel to the axis of rotation). “Thickness” is a measure across the ring along an axis perpendicular to the axis of rotation. Since certain embodiments of the inner and outer rings (12 and 14) are not square or rectangle in cross-section, the width may differ along the thickness of the ring, and vice versa. Given that rings have a thickness, they will have a different circumference inside the wall as compared to outside the wall. As used herein, “outer circumference” refers to the circumference around the outside of the ring, whereas “inner circumference” refers to the circumference around the inside of the ring. The term “outer wall” refers to the outside surface of the wall of the ring running along the outer circumference. The term “inner wall” refers to the inner surface of the wall of the ring that defines the bore. The term “side” or “sides” refer to the outside surfaces of the wall of the ring that define the thickness.

As shown in FIGS. 1-3, the seals 10 of the present disclosure comprise a double-ring internal structure, whereby an inner ring 12 is disposed within an outer ring 14 in coaxial arrangement. By “disposed within”, it is meant that the outer ring 14 encircles the inner ring 12 in coaxial arrangement. “Disposed within” is not intended to mean that the inner ring 12 must have a width that is smaller or the same as the width than the outer ring 14. Rather, it is contemplated in various embodiments herein that the inner ring 12 will have a width that is greater than the outer ring 14, at least at one or more points along the thickness of the inner ring 12. As will be appreciated, by coaxial arrangement it is meant that the inner ring 12 and outer ring 14 are aligned such that they share a common axis of rotation. In this configuration, the outer diameter of inner ring 12 is smaller than the inner diameter of outer ring 14 such that an annular space 22 is formed between the inner and outer rings (12 and 14). Bridge members 16 span the annular space 22 and connect the inner ring 12 to the outer ring 14.

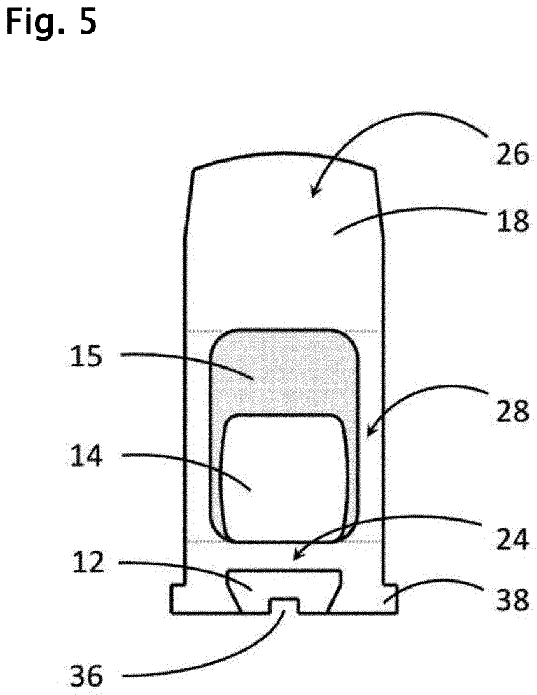

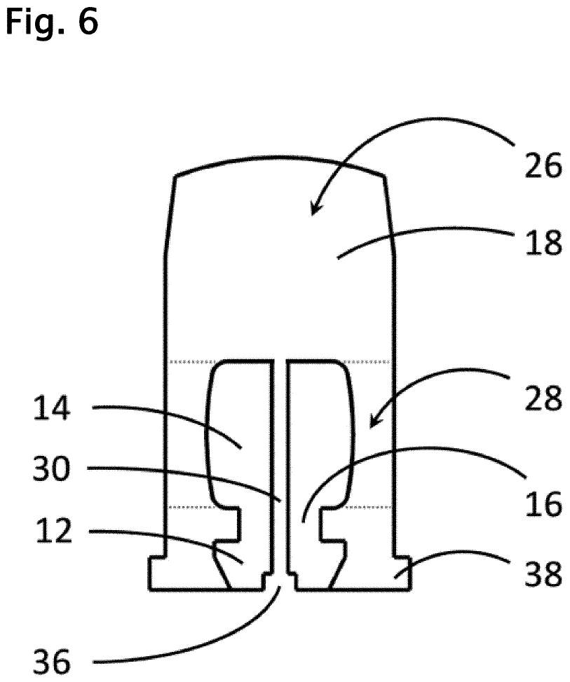

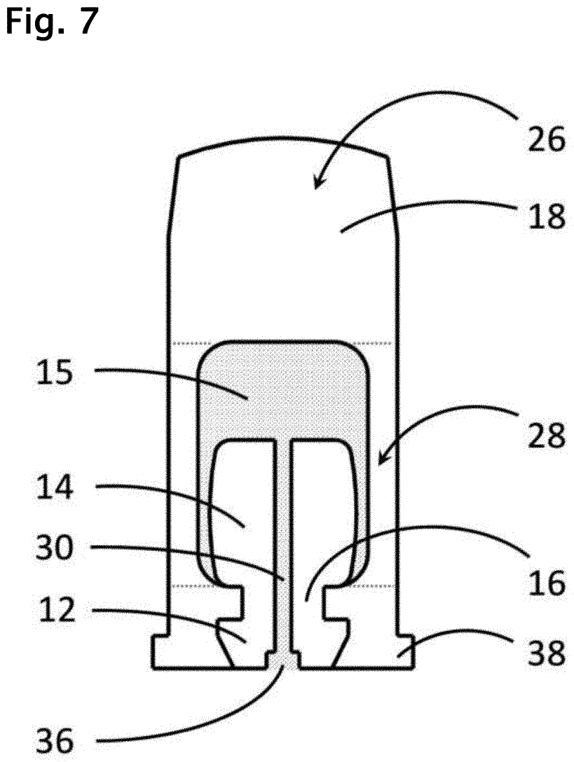

The structure of the double-ring and bridge design provides important functional characteristics to the seals of the present disclosure. As shown in FIGS. 3, 4 and 6, when the expandable material 18 surrounds the outer ring 14 and fills the annular space 22, it forms two opposing regions of expandable material 18 that span the width of the seal 10, an inner seal region 24 within the annular space 22 and an outer region forming a seal ring 26. The inner seal region 24 and seal ring 26 are separated by an expansion region 28 where the expandable material 18 is thin due to the presence of the outer ring 14. Notably, different shapes of outer ring 14 allow for different stretch characteristics of expansion region 28. As shown in FIGS. 5 and 7, when an expansion medium 15 is supplied through a channel 30 to an exterior surface of the outer ring 14, the expansion medium 15 causes the expandable material 18 to pull away from the outer ring 14. The expansion medium 15 accumulates uniformly within the seal 10 around the circumference of the outer ring 14, putting pressure on the expandable material 18 and causing it to expand or stretch at the expansion region 28, thereby pushing the seal ring 26 outwards to sealingly engage the wall of the pipe. Because of the design of the seals and the uniform accumulation and maintenance of expansion medium 15 within the seal, advantageous properties as described herein are achieved, such as the avoidance of floating because the seal is always centered on the bore regardless of diameter change of the seal ring 26.

The inner ring 12, outer ring 14 and bridge members 16 are a solid structure. As used herein, by “solid structure” it is meant that the inner ring 12, outer ring 14 and bridge members 16 are made of a material that is harder and more resistant to expansion than the expandable material 18. The solid structure of the inner ring 12, outer ring 14 and bridge members 16 will retain its form in the presence of pressures imposed by the expansion medium 15.

In an embodiment, the inner ring 12, outer ring 14 and bridge members 16 are made of metal or a metallic alloy. The metal may be, for example and without limitation, iron, copper, aluminum, nickel, titanium or magnesium, and the metallic alloy may be an alloy of these metals, such as steel. In an embodiment, the inner ring 12, outer ring 14 and bridge members 16 are made of the same material. In another embodiment, one or more of the inner ring 12, outer ring 14 and bridge members 16 are made of different materials. In an embodiment, the inner ring 12, outer ring 14 and bridge members 16 are made of steel. The steel may be conventional steel or high tensile steel.

In another embodiment, the inner ring 12, outer ring 14 and bridge members 16 are made of a hard rubber, rigid plastic, composite or ceramic. Embodiments of such materials include those which have a Scale D Shore Durometer hardness of at least 80° Sh. In an embodiment, the material has a Scale D Shore Durometer of between 80° Sh and about 100° Sh. If such a material is to be used for the inner ring 12, outer ring 14 and bridge members 16, it must be highly resistant to being deformed elastically. Minimally, the modulus of elasticity (Young's modulus) value should be at least 10 GPa. More preferably, the modulus of elasticity is at least 50 GPa. In an embodiment, the modulus of elasticity is between about 100 GPa and about 500 GPa.

In an embodiment, the inner ring 12, outer ring 14 and bridge members 16 are a monolithic structure. By “monolithic structure”, it is meant that the inner ring 12, outer ring 14 and bridge members 16 are made or formed from a single piece of material. In an embodiment, the inner ring 12, outer ring 14 and bridge members 16 are formed from a single piece of metal or a metallic alloy. In an embodiment, the inner ring 12, outer ring 14 and bridge members 16 are formed from a single piece of steel. The inner ring 12, outer ring 14 and bridge members 16 may be formed from the single material (e.g. steel) by any means available in the art, including without limitation cutting, grinding, drilling, casting from molten metal (melting and pouring into a mold), and any other known means, or any combination thereof.

The inner and outer rings (12 and 14) can be of any variety of different shapes. As used herein, by “shape” it is meant the shape of the ring at a cross-sectional view (radial cross-section). In an embodiment, the inner and outer rings (12 and 14) are a similar shape. In an embodiment, the inner and outer rings (12 and 14) are different shapes. In an embodiment, the inner ring 12 has a larger width and a smaller thickness than the outer ring 14. The inner and outer rings (12 and 14) may have a different shape at different cross-sections along their circumference. For example, in an embodiment, the sides of the rings (12 and 14) may have a wavy pattern, rather than a uniform straight edge. In a preferred embodiment, the inner and outer rings (12 and 14) have the same shape throughout their circumference.

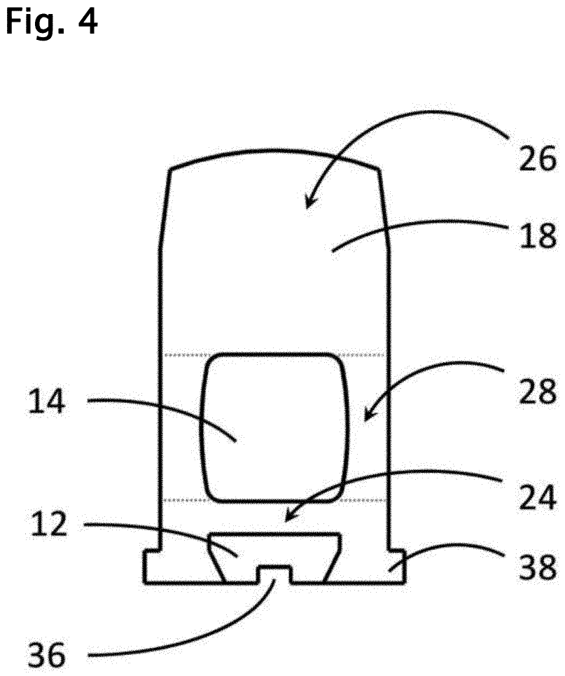

Without limitation, exemplary shapes of the inner ring 12 include a square, rectangle, circle, oval, ellipse, oblong/stadium, rounded rectangle, truncated circle or oval (e.g. a circle or oval with a flat top and bottom), parabola or semi-circle, regular polygon (e.g. triangle, quadrilateral, pentagon, hexagon, heptagon, octagon, nonagon, decagon, etc.), irregular polygon, trapezoid (e.g. isosceles, rhombus, or parallelogram) or kite. The skilled person will appreciated alternate suitable shapes having regard to the disclosure herein. In an embodiment, the shape may resemble any of the straight-edged shapes described above (e.g. polygons), with curved edges in place of one or more of the straight edges. In an embodiment, the inner ring 12 is a square, rectangle or isosceles trapezoid. In a particular embodiment, the inner ring 12 is a rectangle with a larger width than thickness. In another particular embodiment, the inner ring 12 is an isosceles trapezoid with the parallel sides (i.e. bases) defining the inner wall and outer wall of the ring, and with the larger base at the outer wall and the shorter base at the inner wall defining the bore of the inner ring 12, such as shown in FIG. 4. In an embodiment, the non-parallel sides or walls of the trapezoid may comprise a jagged edge.

Without limitation, exemplary shapes of the outer ring 14 include a square, rectangle, circle, oval, ellipse, oblong/stadium, rounded rectangle, truncated circle or oval (e.g. a circle or oval with a flat top and bottom), parabola or semi-circle, regular polygon (e.g. triangle, quadrilateral, pentagon, hexagon, heptagon, octagon, nonagon, decagon, etc.), irregular polygon, trapezoid (e.g. isosceles, rhombus, or parallelogram) or kite. The skilled person will appreciated alternate suitable shapes having regard to the disclosure herein. In an embodiment, the shape may resemble any of the straight-edged shapes described above (e.g. polygons), with curved edges in place of one or more of the straight edges. In an embodiment, the outer ring 14 is a circle, oval, ellipse, oblong, rounded rectangle, or truncated circle or oval. In a particular embodiment, the outer ring 14 is an oval or ellipse having a larger thickness than width. In another particular embodiment, the outer ring 14 is a truncated circle or oval with the truncated (straight) edges defining the inner wall and outer wall of the outer ring 14, and with a larger thickness than width. In another particular embodiment, the outer ring 14 is generally the shape of a rounded square, such as shown in FIG. 4.

The diameter, width and thickness of the inner and outer rings (12 and 14) will depend on a variety of factors, including without limitation, the type of expandable material 18, size of the head unit of a line-stopping tool, including the diameter of an internal structure onto which the seals 10 may be mounted, size of the seal 10, size of the pipe that is to be sealed, and operating conditions within the pipeline (e.g. pipeline pressures). A larger pipe will require a larger seal which, in turn, will typically have larger inner and outer rings (12 and 14). Also, the bore size of the inner ring 12 may preferably be of complementary size to mount onto or interface with the core 66 of the head unit of the line-stopping tool as described elsewhere herein.

As described herein, the inner ring 12 is disposed within the outer ring 14. In such configuration, the outer diameter of the inner ring 12 will be smaller than the inner diameter of the outer ring 14 so as to form an annular space 22 between the rings (12 and 14). As the skilled person will appreciate, the annular space 22 is a void between the inner and outer ring (12 and 14). In the seal of the present disclosure, the annular space 22 is filled with the expandable material to form the inner seal region 24. The inner seal region 24 is a region between the inner and outer rings (12 and 14) where the expandable material extends the width of the seal. In this position between the inner and outer rings (12 and 14), the inner seal region 24 within the annulus 22 functions to retain the bottom of the expandable material in place, while allowing stretching of the material at the sides of the outer ring 14 (i.e. expansion region 28) to expand the seal 10 during activation.

The annular space is maintained, and the inner and outer rings (12 and 14) are held together, by one or more bridge members 16. The bridge members 16 span the annular space 22 and connect the inner ring 12 to the outer ring 14. As described elsewhere herein, the bridge members 16 may be made of the same or different material as the inner and/or outer rings (12 and 14). In a particular embodiment, the inner ring 12, outer ring 14 and bridge members 16 are made of the same material and may further be a monolithic structure. In an embodiment, there is at least one bridge member 16. In another embodiment, there are 1, 2, 3, 4, 5, 6, 7, 8, 9, 10, 11, 12, 13, 14, 15, 16, 17, 18, 19, 20 or more bridge members. In a preferred embodiment, there are at least two bridge members 16. In a more preferred embodiment, there are 2, 3, 4 or 5 bridge members 16.

In an embodiment as shown in FIGS. 1, 6 and 7, the bridge members 16 are within the annular space 22 and have a width that is less than that of the inner and outer rings (12 and 14), i.e. the bridge members 16 do not extend outwards beyond the width of the inner and/or outer rings (12 and 14). In another embodiment, the bridge members 16 may have a width that is the same or greater than that of the inner and/or outer rings (12 and 14). In another embodiment, the bridge members 16 may attach to the sides of the inner and outer rings (12 and 14) such that they are external to the annular space 22. Any combination of these configurations of the bridge members 16 may also be used.

The bridge members 16 are of sufficient size and design to resist the pressures of the expansion medium 15 and maintain the inner and outer rings (12 and 14) in their respective positions to each other within the seal 10. With that said, it is desirable for a minimal amount of the annular space 22 to be occupied by the bridge members 16 since it decreases the amount of space that can form the inner seal region 24. The larger in size and/or number of bridge members 16, the smaller the space where the expandable material spans the full width of the seal 10. In a preferred embodiment, the seal comprises only 3 or 4 bridge members 16. In a further preferred embodiment, the bridge members 16 have a width that is less than the inner and outer rings (12 and 14) so that even at the bridge members 16, the expandable material 18 is thicker than at the sides of the outer ring 14, i.e. the expansion region 28.

With a view to maintaining a uniform sealing pressure around the seal 10, it may also be desirable to have the bridge members 16 spaced equidistant from each other around the annular space 22. Thus, in an embodiment, the bridge members are equidistant from each other in the annular space 22. However, this may not be necessary depending on the size and shape of each of the bridge members 16.

The bridge members may be of any suitable shape. Without limitation, exemplary shapes of the bridge members 16 include a square, rectangle, circle, oval, ellipse, oblong/stadium, rounded rectangle, truncated circle or oval (e.g. a circle or oval with a flat top and bottom), parabola or semi-circle, regular polygon (e.g. triangle, quadrilateral, pentagon, hexagon, heptagon, octagon, nonagon, decagon, etc.), irregular polygon, trapezoid (e.g. isosceles, rhombus, or parallelogram) or kite. The skilled person will appreciated alternate suitable shapes having regard to the disclosure herein. In an embodiment, the shape may resemble any of the straight-edged shapes described above (e.g. polygons), with curved edges in place of one or more of the straight edges. In an embodiment, the bridge members 16 are a square, rectangle, oval, oblong, rounded rectangle or truncated circle or oval. In a particular embodiment, the bridge members 16 are a concave rectangle shape in which the sides that do not contact the inner and outer rings (12 and 14) are concave. In embodiments that comprise more than one bridge member 16, each of the bridge members 16 may independently be the same or a different shape. In an embodiment, all of the bridge members 16 are a concave rectangle shape.

As described later herein, in embodiments in which there are a significant number of bridge members 16 and/or the bridge members 16 occupy a significant portion of the annular space 22, the inner and outer ring (12 and 14) structure as described herein may be more aptly characterized as a single ring with holes. This embodiment is described in greater detail herein below and is encompassed within the ‘dual’ inner ring 12 and outer ring 14 structure of seal 10 described herein. As such, the structures and features of seal 10 comprising a ‘dual’ inner/outer ring design described herein are equally applicable to a seal 10 comprising the ‘single’ ring embodiment. The seal 10 of the present disclosure may thus be characterised as comprising a ‘dual ring’ (outer/inner ring) structure or a ‘single ring’ structure depending largely on the number, size and shape of the bridge members 16 and annular space 22.

The seal 10 of the present disclosure further comprises at least one channel 30 configured for providing fluid communication between the bore of the inner ring 12 and an exterior surface of the outer ring 14. By “fluid communication” it is meant that a fluid and/or gas is able to pass through the channel 30 from the bore of the inner ring 12 into the seal 10 to an exterior surface of the outer ring 14. In essence, the channel 30 is for delivering the expansion medium 15 from within the head unit of the line-stopping tool to an exterior surface of the outer ring 14. The channel 30 may also be used to deliver other fluids and gases to the seal 10, such as a cleaning solution to clean the seal after its activation and prepare the seal for re-use.

As shown in FIGS. 3, 6 and 7, in an embodiment, the channels 30 are formed by passageways through the bridge members 16. In an example of such an embodiment, there is a first port 32 on a surface of the inner wall of the inner ring 12 (i.e. on a surface of the bore of the inner ring 12); a second port 34 on an exterior surface of the outer ring 14; and a passageway therebetween that passes through the inner ring 12, one of the bridge members 16, and the outer ring 14. The passageway between the first and second ports (32 and 34) provides fluid communication between the bore and the exterior surface of the outer ring 14. The passageway may be a continuous hole in the material of the inner ring 12, outer ring 14 and bridge member 16 that forms a channel or the passageway may be a tubing that runs through the inner ring 12, outer ring 14 and bridge member 16.

There are a number of different arrangements and configurations of channels 30 that may be used. In an embodiment, the seal 10 has one channel for every bridge member 16, each of the channels having its own first port 32 and second port 34 in respective alignment to provide a passageway from the bore to an exterior surface of the outer ring 14. In another embodiment, a first port 32 may feed two or more passageways that pass through one or more bridge members 16 to a respective number of two or more second ports 34. In another embodiment, two or more first ports 32 may feed the same passageway to a single second port 34. The skilled person will appreciate based on the present disclosure a suitable configuration of channels 30 for any particular seal 10. Irrespective of the configuration of the channels 30, a desirable property may be to maintain a uniform distribution of expansion medium 15 to around the outer ring 14 in order to provide a uniform sealing engagement and prevent floating.

The location of the first port 32 and second port 34 may also be at different positions on the inner wall of the inner ring 12 and exterior surface of the outer ring 14, respectively.

In an embodiment, the first port 32 is positioned at a mid-point along the width of the inner ring 12. In an embodiment, similar to the bridge members 16, the first port 32 for each channel 30 is spaced equidistant from each other on the inner wall of the inner ring 12. In an embodiment, the first port 32 for each channel 30 is radially aligned with a bridge member 16. Indeed, for ease of manufacture, the channels 30 may be formed by drilling a straight passageway from the outer wall of the outer ring 14 straight through a bridge member 16 and through the inner ring 12.

In an embodiment, and to aid in uptake of expansion medium 15 into the first ports 32, the inner ring 12 may comprise a groove 36 extending around the circumference of the inner wall of the inner ring, and the first ports 32 may be positioned within the groove 36. As shown in FIGS. 4-9, the groove 36 is ditch-like structure running around the circumference of the inner wall of the inner ring 14. The groove 36 may be of any suitable shape and, in an embodiment, is a rectangle, square, or semi-circle shaped ditch. In an embodiment, the size of the groove 36 (width and depth) is larger than that of the channels 30 such that fluids and/or gas move more readily within the groove 36 than in the channels 30. This design will promote even distribution of the expansion medium 15 throughout the entire length of the groove 36 before the expansion medium 15 enters the channels 30, thus aiding in uniform delivery of expansion medium 15 around the outer ring 14 and into the seal 10.

The second port 34 may be at any location on an exterior surface of the outer ring 14. By “exterior surface”, it is meant any exterior surface on the outer wall, sides or inner wall of the outer ring 14. In an embodiment, the second port 34 is positioned at a mid-point along the width of the outer wall of the outer ring 14. In an embodiment, similar to the bridge members 16, the second port 34 for each channel 30 is spaced equidistant from each other on the outer wall of the outer ring 14. In an embodiment, the second port 34 for each channel 30 is radially aligned with a bridge member 16.

As described above, the outer ring 14 may be a shape having a curved outer wall. In an embodiment, the second port 34 on the exterior surface of the outer ring 14 is at a position most radially outwards from the co-axis of the inner and outer ring (12 and 14). By this, it is meant that the second port 34 is located at an exterior surface of the outer ring as far outwards as possible towards and immediately under the seal ring 26. In another embodiment, the second port 34 is positioned at a mid-point along the width of the inner wall of the outer ring 14. In another embodiment, the second port 34 is positioned on one or both sides of the outer ring 14. In a particular embodiment, there are second ports 34 located at both sides of the outer ring 14. The two second ports 34 on the sides of the outer ring 14 may be in fluid communication with the bore of the inner ring 12 via a single passageway that splits in the outer ring 14 to communicate with both second ports 34 or by two separate passageways. Other suitable positions for the second port 34 at an exterior surface of the outer ring 14 will be appreciated by the skilled person having regard to the present disclosure.

The embodiments above describe the channels 30 as passageways through the inner ring 12, outer ring 14 and bridge member 16. While it is believed that this may be a preferable design in regards to ease of manufacture and strength of the seals, other configurations of channels 30 are possible and are contemplated. For example, in an embodiment, the channels 30 may be tubing that run exterior to the inner ring 12, outer ring 14 and bridge members 16. In such embodiments, the tubing would be within the expandable material 18 and may be attached to the sides of the inner ring 12, outer ring 14 and bridge members 16.

The seal 10 of the present disclosure further comprises an expandable material 18. In an embodiment, the expandable material 18 surrounds the outer ring 14. As used herein, the term “surrounds” or “surrounding” means to cover all exposed surfaces of an object (e.g. the outer ring 14) so as to encase the object in the expandable material 18. As will be appreciated, some of the surfaces of the objects may not be exposed as they may be covered by other objects. For example, in embodiments herein, a portion of the surface of the outer ring 14 may be covered by bridge members 16. In such embodiments, the term surrounds means to cover the exposed surfaces of the object, and may or may not include covering the adjoining object.

By surrounding the outer ring 14, the expandable material 18 forms a region within the annular space 22 whereby the expandable material extends the full width of the seal 10. This region is referred to herein as the inner seal region 24 and may be divided into separate sections by the bridge members 16. The expandable material 18, in surrounding the outer ring 14, also forms another region extending around and outwardly from the outer circumference of the outer ring 14 where the expandable material 18 also extends the full width of the seal 10. This region is referred to herein as the seal ring 26. Due to presence of the outer ring 14, the expandable material 18 is thinner between the inner seal region 24 and the seal ring 26 because the expandable material 18 cannot extend the full width of the seal 10. This region of expandable material 18 between the inner seal region 24 and the seal ring 26 is referred to herein as the expansion region 28.

In an embodiment, in addition to surrounding the outer ring 14, the expandable material 18 also fills the annular space 22 and surrounds the bridge members 16 and the inner ring 12 outside the bore. By surrounding the inner ring 12 outside the bore, it is meant that the expandable material 18 covers the outer wall and sides of the inner ring 12, but does not cover the inner wall that forms defines the bore. Thus, in this embodiment, the expandable material 18 does not surround the entirety of the inner ring 12 because it is not present within the bore. In a further embodiment, the expandable material 18 may surround the entirety of the inner ring, as long as there remains access to the channel 30 that provides fluid communication between the bore and an exterior surface of the outer ring 14.

In an embodiment of the seals 10 disclosed herein, the expandable material 18 surrounds the outer ring 14 such that there are no pockets of air remaining within the seal 10 in a region where the expansion medium 15 will be distributed. This is an advantageous configuration for expansion of the seal 10 since there is no air present that will need to be displaced or removed and it aids in uniform expansion upon activation of the seals 10. This also prevents a collapse or ‘imploding’ experienced when the seals 10 are exposed to external pressure.

Outwardly from the outer ring 14, the expandable material forms the seal ring 26 around the outer circumference of the outer ring 14. The seal ring 26 forms the outermost component of the seal 10. The seal ring 26 is, in essence, a ring of expandable material 18 that is concentric with the inner and outer rings (12 and 14). The expandable material 18 of the seal ring 26 extends the width of the seal 10. It is the seal ring 26 that expands outwardly to sealingly engage the wall of the pipe when the seal 10 is activated by the expansion medium 15. The expansion medium 15 causes the expandable material 18 in the expansion region 28 to stretch and expand, and since the seal 10 is confined within the head unit, expansion is consequently in the radial outward direction causing the seal ring 26 to expand and move outwards to engage the wall of the pipe.

The seal ring 26 may be of various different thicknesses depending on, for example, the type of expandable material 18, size of the seal 10, size of the outer ring 14, size of pipe to be sealed, and conditions within the pipeline (e.g. operating pressures). Similar to the inner and outer rings (12 and 14), by “thickness” of the seal ring 26, it is meant to refer to the measure across the seal ring 26 along an axis perpendicular to the axis of rotation. The width of the seal ring 26 will typically be consistent with the width of the seal 10. The seals 10 herein can be of any number of different widths depending on, for example, the design of the head unit of the line-stopping tool, type of expandable material 18, diameter of the seal 10, size (e.g. width) of the inner and outer rings (12 and 14), size of the pipe to be sealed, and conditions within the pipeline (e.g. operating pressures).

Although the expandable material 18 is a softer and more elastic material than the inner ring 12, outer ring 14 and bridge members 16, the expandable material 18 is still sufficiently hard and rigid to withstand the operating pressures of the pipeline and maintain a sealing engagement with the wall of the pipe.

In an embodiment, the expandable material 18 has a Scale A Shore Durometer of at least 75° Sh. In an embodiment, the expandable material 18 has a Scale A Shore Durometer of between about 75° Sh and about 100° Sh. In an embodiment, the expandable material 18 has a Scale A Shore Durometer of about 75° Sh, about 80° Sh, about 85° Sh, about 90° Sh, about 95° Sh or about 100° Sh. In a particular embodiment, the expandable material 18 has a Scale A Shore Durometer of about 90° Sh.

In an embodiment, the expandable material 18 has a modulus of elasticity (Young's modulus) of no higher than about 0.1 GPa (about 14,500 psi). In an embodiment, the expandable material 18 has a modulus of elasticity of between about 0.0035 GPa and about 0.07 GPa (about 500 psi to about 10,000 psi). In an embodiment, the expandable material 18 has a modulus of elasticity of between about 0.015 GPa and about 0.05 GPa (about 2500 psi to about 7,500 psi). In an embodiment, the expandable material 18 has a modulus of elasticity of about 0.03 GPa (about 4400 psi).

In an embodiment, the expandable material 18 is a rubber material or an equivalent thereof. The rubber material may be a natural or synthetic rubber, or combination thereof. By an “equivalent thereof”, it is meant any material having similar functional properties to rubber in respect of elasticity, hardness and permeability. In an embodiment, the rubber material has a Scale A Shore Durometer of between about 75° Sh and about 100° Sh and a modulus of elasticity of between about 0.01 GPa and about 0.06 GPa (about 1,500 psi to about 8,600 psi). In an embodiment, the rubber material has a Scale A Shore Durometer of about 90° Sh and a modulus of elasticity of about 0.03 GPa (about 4,400 psi). In an embodiment, the rubber material is a urethane rubber. In an embodiment, the expandable material 18 is polyurethane 90A.

As shown in FIGS. 4-9, in a further embodiment of the seals 10 of the present disclosure, the expandable material 18 forms a lip 38 extending longitudinally outward from each side of the inner ring 12, each lip encircling and further defining the bore. By “extending longitudinally outward”, it is meant that the expandable material 18 extends outwardly from each side of the inner ring in a direction parallel to the axis of rotation of the inner ring 12. In an embodiment, the lip 38 extends all the way around the bore and thus increases the length of the bore of the inner ring 12. In such embodiments, the lip 38 is said to encircle the bore. In another embodiment, the lip 38 may not completely encircle the bore, but rather may be fragmented such that there are one or more smaller lips 38 extending longitudinally outwards from each side of the inner ring 12. When placed within a head unit of a line-stopping tool, the lip 38 may provide additional structural support since the lip can be aligned with a corresponding indent or groove in the head unit. This may assist in maintaining the seal 10 in position and further preventing floating. Also, the lip 38 may provide a further sealing engagement between the head unit and the seal 10, preventing pipeline fluids or gases from getting into the head unit and preventing expansion medium 15 from leaking out of the head unit (e.g. keeping it within groove 36).

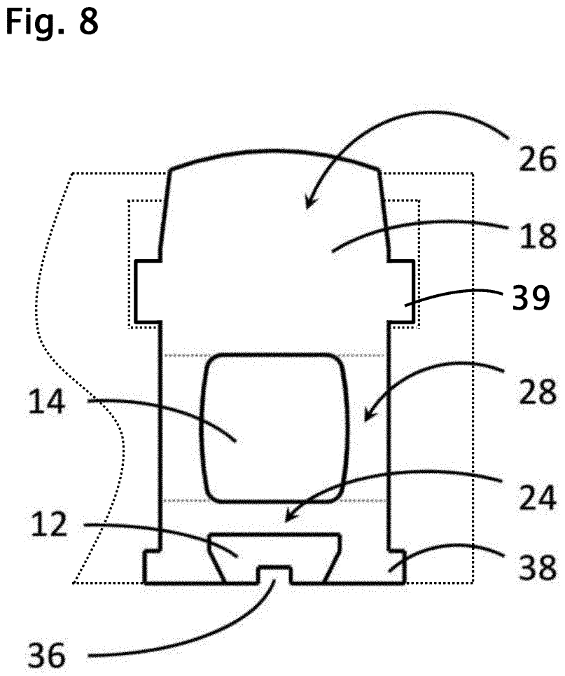

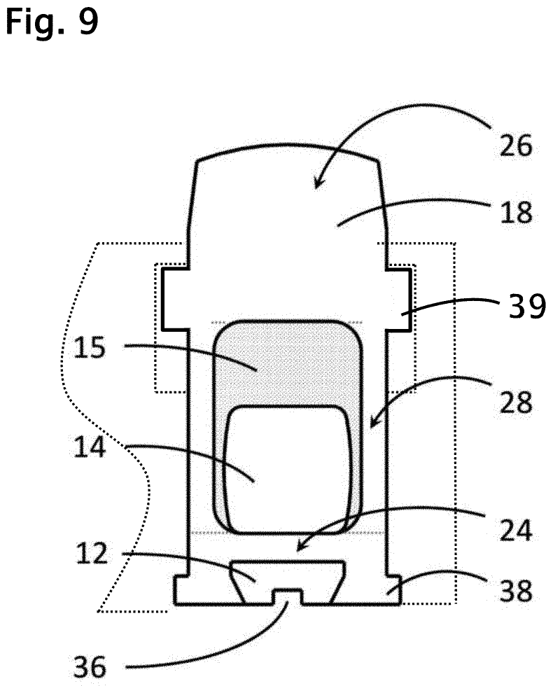

In the embodiment of the seal 10 shown in FIG. 4, the lip 38 is the only protrusion extending longitudinally outwards from the sides of the seal 10. In some embodiments, the seal 10 may include one or more further protrusions extending longitudinally outwards from one or both sides of the seal 10, thereby increasing the width of the seal 10 at that region. An exemplary embodiment is shown in FIGS. 8 and 9. These protrusions are referred to herein as a shoulder 39. In an embodiment, the shoulder 39 runs all the way around one or both sides of the seal 10. When the shoulder 39 is on both sides of the seal 10, it may be in the same (i.e. complementary) or a different position on the opposing side. In the line-stopping tool of the present disclosure, the shoulder 39 will fit into a recess in the head unit. In an embodiment, the recess is larger than the shoulder 39 such that the shoulder 39 and recess may be used in combination to control expansion of the seal 10. For example, comparing FIG. 8 (inactivated seal) with FIG. 9 (activated seal), it can be seen that upon expansion of the seal 10 the shoulder 39 will move within the recess. When the shoulder abuts the outermost wall of the recess, it will prevent further expansion of the seal 10.

The shoulder 39 can serve several useful functions. For one, the shoulder 39 and recess can be used to test the functioning of the seals 10 prior to installation of the line-stopping tool within a pipeline. When testing expansion of the seals 10, the shoulder 39 and recess can be used together to prevent overexpansion of the seal 10. Upon expansion, the shoulder 39 will slide within the recess to abut the outermost wall, thereby preventing the expansion material 18 from breaking in the expansion region 28. For another, when installed within a pipe on a line-stopping tool, the shoulder 39 and recess combination can act to change the path of least resistance of expansion, thereby aiding in centering and avoiding the ‘floating’ seal phenomenon.

As shown in FIG. 1, certain embodiments of the seals 10 of the present disclosure may include a spring. The spring may be of any suitable diameter, shape, wire thickness and material. In an embodiment, the shape of the spring is round, square or oval. In an embodiment, the spring is made of metal or a metallic alloy. The spring may itself form a ring within the seal 10, such as shown for example in FIG. 1. Alternatively, smaller pieces of spring may be appropriately positioned within the seal 10. The seal 10 may include any number of springs in any number of different positions within the seal 10.

In an embodiment, the spring is a circular spring positioned within the seal ring 26 in co-axial arrangement with the seal ring 26 (e.g. as shown in FIG. 1). Herein, a spring positioned within the seal ring 26 may be referred to interchangeably as a “seal spring” 20. In a preferred embodiment, the diameter of the seal spring 20 is larger than the gap formed between the head unit of a line-stopping tool and the wall of a pipe when the line-stopping tool is positioned within the pipe. In this manner, the seal spring 20 cannot easily be pushed into the gap and the seal spring 20 will provide additional resistance to the pressures within the pipeline to aid in maintaining a strong sealing engagement by the seal 10 against the pipe. Thus, one function of the seal spring 20 is to prevent the outer region of the seal ring 26 from extruding parallel to the pipe wall. Additionally, the seal spring 20 aids in retracting the expandable material 18, and in particular the seal ring 26, during deactivation of the seal 10.

In an embodiment, the seal spring 20 is positioned within the seal ring 26 such that when the seal 10 is in position within a pipe in a line-stopping tool, the seal spring 20 is at a downstream side of the seal ring 26. By “downstream side”, it is meant the side of the seal ring 26 that is on the same side as the isolated section of pipe. The “downstream side” may interchangeably be referred to herein as the “back side” of the seal ring 26. In contrast, the “upstream side” or “front side” of the seal ring 26, used interchangeably herein, refers to the side of the seal ring 26 that is on the operational side of the pipeline where fluids and/or gas are to be sealed-off from the downstream isolation section. While orientation of the seal spring 20 towards the back side may be preferred, the seal spring 20 can be positioned in the front side, center or back side of the seal ring 26, or any combination thereof in embodiments with multiple seal springs 20.

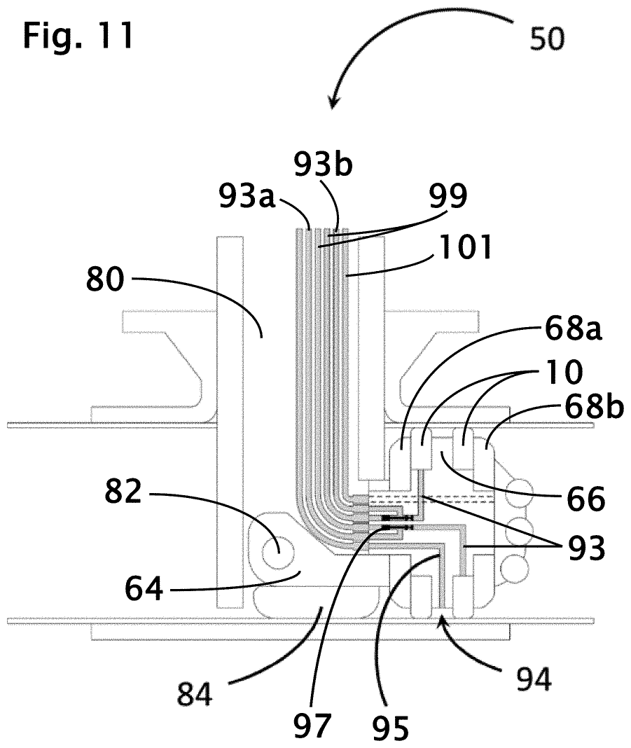

As will be appreciated, since the seals 10 and line-stopping tool of the present disclosure are bi-directional, the “front side” and “back side” of the seal ring 26 may alternate depending on which direction the pipeline is being isolated. In embodiments where the head unit comprises two seals 10, the seal spring 20 may be oriented toward the side of the seal ring 26 that faces the other seal 10 (i.e. oriented towards the interior space 94 as indicated in FIG. 11). This configuration may be preferred if the line-stopping tool is to be used in a bi-directional manner without changing the seals 10. In another embodiment, the seal spring 20 may be oriented at the back side of both seals 10 such that if the upstream seal 10 were to fail, the downstream seal 10 would be in the same orientation. This configuration may be preferred if the line-stopping tool is not to be used in a bi-directional manner.

In another embodiment, there may be a spring within the shoulder 39. A spring positioned within a shoulder 39 may referred to herein as a “shoulder spring”. The shoulder spring 26 will provide additional strength to the shoulder 39, thereby aiding in its functionality as described herein. The shoulder 39 may include one or more shoulder springs of any length, design and position within the shoulder 39. In a preferred embodiment, a shoulder spring will span the entire length of the shoulder 39 (i.e. extending all the way around the seal 10 in the shoulder 39). In other embodiments, one or more shoulder springs may be interspersed within the shoulder 39 at various positions. In other embodiments, any combination of the above shoulder spring configurations may be used in the shoulder 39.

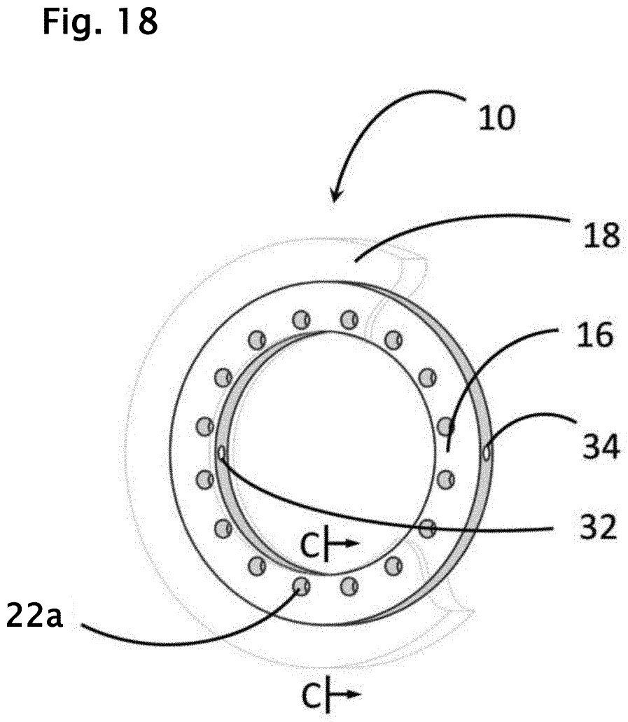

In addition to a ‘dual ring’ structure comprising an inner ring 12 and an outer ring 14, it will be appreciated that the seal 10 as described herein may be characterized as a ‘single ring’ structure depending on the size, number and shape of the bridge members 16 and the annular space 22. For example, as depicted in FIG. 18, when the bridge members 16 occupy a significant portion of the annular space 22, the ‘dual ring’ structure may be more aptly characterised as a ‘single ring’ with holes 22a spanning the width of the ring. A seal 10 comprising the ‘single ring’ structure shares the attributes, features and functions of a seal 10 comprising the ‘dual ring’ (inner ring 12 and outer ring 14) structure already described. The holes 22a in the single ring are in effect the annular space 22, and each hole 22a functions in the same manner as the inner seal region 24.

Thus, in some embodiments, the present disclosure relates to a seal for a line-stopping tool, the seal comprising a ring defining a bore and having a width and a thickness, the ring having one or more holes spanning the width and open to both a first and second side of the ring; at least one channel configured for providing fluid communication between the bore of the ring and an exterior surface of the ring outside the bore; and an expandable material covering at least the surfaces of the ring outside the bore, the expandable material forming a seal ring extending around and outwardly from an outer circumference of the ring.

The holes 22a spanning the width of the ring may be of any suitable size and shape. In an embodiment, the holes 22a are a circle, square, rectangle, oval, rounded square or rounded rectangle shape. In an embodiment, the shape of the holes 22a is arched to follow the curve of the ring, e.g. an arched rectangle. The ring can comprise any number of holes 22a and the holes 22a may be of any combination of shapes. In a preferred embodiment, the holes 22a will be of the same size, shape and circumferential position all the way around the seal, and will be equidistant to each other. By the “same circumferential position”, it is meant that the holes 22a are aligned circumferentially such that each hole 22a is positioned at about an equal distance from the bore along the thickness of the ring.

In an embodiment, the ring comprises four or more of the holes 22a. In an embodiment, the ring comprises between 8 and 40 of the holes 22a. In an embodiment, the ring comprises 8, 9, 10, 11, 12, 13, 14, 15, 16, 17, 18, 19 or 20 of the holes 22a. In an embodiment, the holes 22a are circular, square or rectangle. In an embodiment, the ring comprises 16 of the holes 22a and the holes 22a are circular.

The channels 30 are as described above for the dual outer/inner ring design and are configured for providing fluid communication between the bore of the ring and an exterior surface of the ring outside the bore. The seal 10 comprising a ‘single ring’ structure may comprise any number of channels 30. In an embodiment, there are at least four channels 30 spaced equidistantly around the ring and passing through the bridge members 16. In an embodiment, there is a channel 30 in every second, third or fourth bridge member 16. In an embodiment, there is a channel 30 in every bridge member 16. Similar to an embodiment of seal 10 having a ‘dual ring’ structure, in an embodiment of a seal 10 comprising a ‘single ring’ structure each of the at least one channels may individually comprises a first port 32 on a surface of the bore of the ring, a second port 34 at the outer circumference of the ring, and (iii) a passageway therebetween through the ring (as shown in FIG. 18).

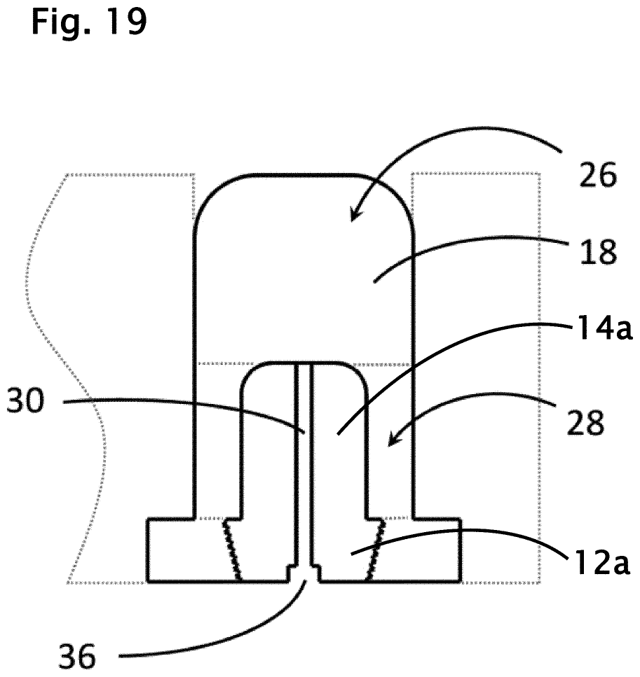

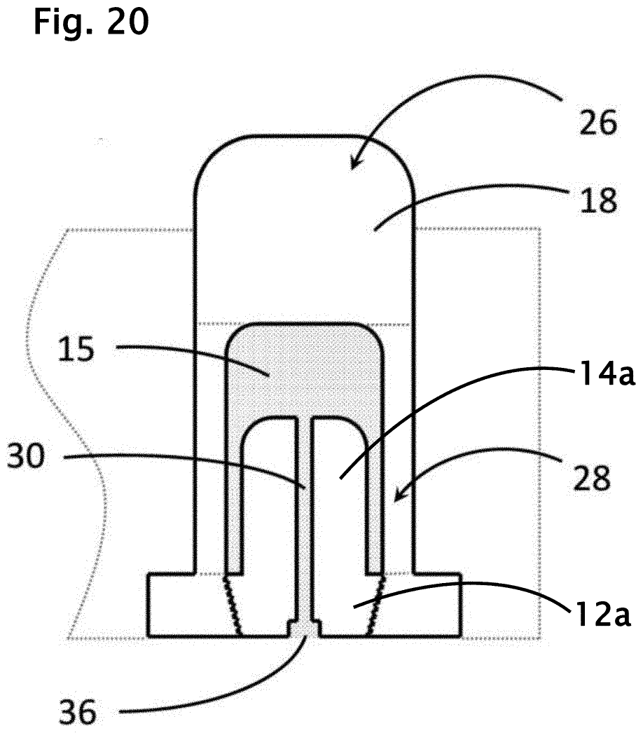

The shape of the ‘single ring’ structure is similar to that of the ‘dual ring’ structure as described herein. Again, as used herein, by “shape” it is meant the shape of the ring at a cross-sectional view (radial cross-section). For the ‘single ring’ embodiment, the inner portion 12a of the ring proximal to the bore and radially inwards of the holes 22a is equivalent to the inner ring 12 and may have any shape as described herein for the inner ring 12. The outer portion 14a of the ring distal to the bore and comprising of the holes 22a and outward therefrom is equivalent to the outer ring 14 and may have any shape as described herein for the outer ring 14. In an embodiment of the ‘single ring’ embodiment, the inner portion 12a of the ring has a trapezoid shape in radial cross-section and the outer portion 14a of the ring has a rounded rectangle shape, as shown in FIGS. 19 and 20. In an embodiment, the non-parallel sides of the trapezoid shape forming the inner portion 12a have a jagged edge.

Other features of a seal 10 comprising a ‘single ring’ structure are as described herein in respect of a ‘dual ring’. Indeed, it is intended herein that the ‘single ring’ structure an embodiment encompassed within the ‘dual ring’ structure.

As described above, when an expansion medium 15 is supplied through a channel 30 to an exterior surface of the outer ring 14, the expansion medium 15 causes the expandable material 18 to pull away from the outer ring 14. The expansion medium 15 accumulates uniformly within the seal 10 around the circumference of the outer ring 14, putting pressure on the expandable material 18 and causing it to expand or stretch at the expansion region 28, thereby pushing the seal ring 26 outwards to sealingly engage the wall of the pipe. A similar mode of expansion occurs with the ‘single ring’ embodiment, as shown in FIG. 18. In addition, the sides of inner ring 12 or inner portion 12a (e.g. a jagged edge), together with the surfaces of the core 66 and one of the opposing ends (68a or 68b) that contact the expandable material 18, hold the expandable material 18 against the bore in a manner similar to seal region 24, thereby holding the expandable material 18 in place from the outside of the seal 10. Because of the design of the seals 10 and the uniform accumulation and maintenance of expansion medium 15 within the seal 10, advantageous properties as described herein are achieved, such as the avoidance of floating.

Other advantageous properties of the double-ring and bridge design of the seals 10 of the present disclosure include, without limitation, the ability to: easily fluidly connect a fluid conduit in a line-stopping tool with the channels 30 to deliver expansion medium 15; prevent and avoid leaking seals by providing a clamping surface, including lip 38; and prevent seal collapse before activation (i.e. expansion) by having a strong internal support structure. In particular, seals 10 of the present disclosure avoid implosion since a retracted seal (e.g. de-activated) is completely solid with no voids (e.g. air pockets).

### Line-Stopping Tool

In another aspect, the present disclosure relates to a line-stopping tool that solves many issues with previously known hot-tap tools, exceeds the full criteria of a DBB system, and delivers capabilities and protection of a DBB system.

In an embodiment, the present disclosure relates to a line-stopping tool comprising a seal 10 as described herein.

In an embodiment, the present disclosure relates to a line-stopping tool for plugging a pipe, the line-stopping tool comprising: a head unit configured for location in a section of a pipe, the head unit comprising at least one seal configured to engage the wall of the pipe to plug the section of the pipe, wherein the at least one seal comprises: (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring, a carrier unit having a pivotal connection to the head unit, and a fluid conduit in fluid communication with one or more of the at least one channels, and configured for providing an expansion medium the at least one seal.

In an embodiment, the present disclosure relates to a line-stopping tool for plugging a pipe, the line-stopping tool comprising: a head unit configured for location in a section of a pipe, the head unit comprising at least one seal configured to engage the wall of the pipe to plug the section of the pipe, wherein the at least one seal comprises: (i) a ring defining a bore and having a width and a thickness, the ring having one or more holes spanning the width and open to both a first and second side of the ring; (ii) at least one channel configured for providing fluid communication between the bore of the ring and an exterior surface of the ring outside the bore; and (iii) an expandable material covering at least the surfaces of the ring outside the bore, the expandable material forming a seal ring extending around and outwardly from an outer circumference of the ring, a carrier unit having a pivotal connection to the head unit, and a fluid conduit in fluid communication with one or more of the at least one channels, and configured for providing an expansion medium to the at least one seal.

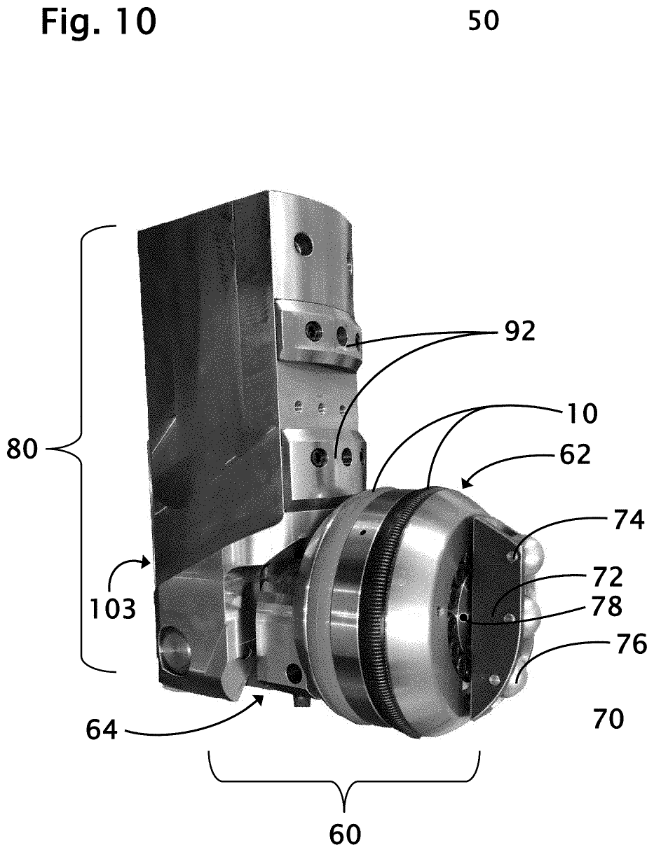

Referring to FIGS. 10-12, there is shown a line-stopping tool 50 according to an embodiment of the present disclosure. The embodiment in FIGS. 10-12 comprises two seals 10 as disclosed herein. A line-stopping tool 50 of the present disclosure may comprise only one seal 10 or may comprise one or more seals 10 alone or in combination with another type of seal, on one or more head assemblies.

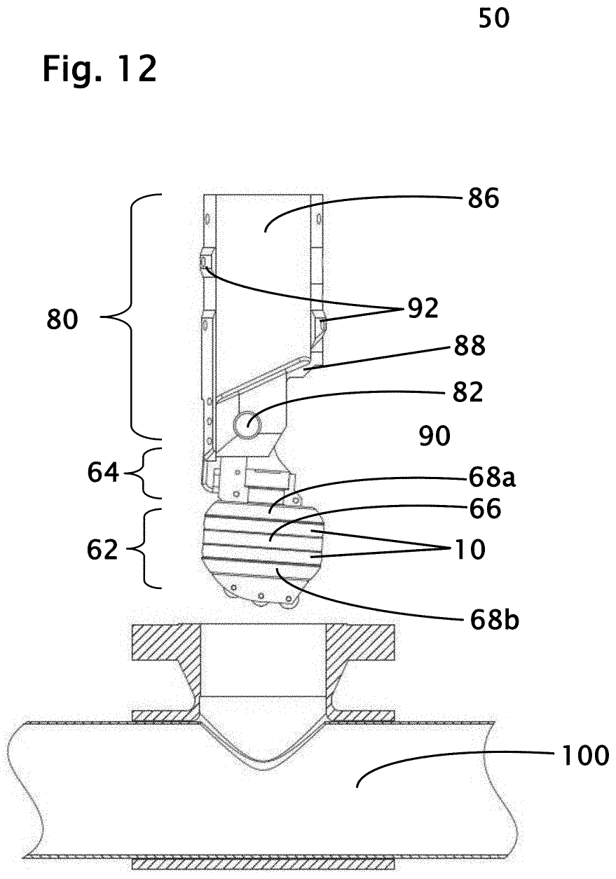

FIG. 10 is an image of an embodiment of a line-stopping tool 50 of the present disclosure, whereas FIGS. 11 and 12 are perspective drawings. FIG. 11 provides an internal view of an embodiment of a line-stopping tool 50 showing the various conduits as described elsewhere herein. In both of FIGS. 10 and 12, the line-stopping tool 50 is shown prior to activation, whereas in FIG. 11 the seals 10 have been activated. By “activation”, as used herein, it is meant that the seals 10 have been activated using an expansion medium 15 and are in an expanded state. Prior to activation, the seals 10 are in a retracted state. As shown in FIGS. 10 and 12, the line-stopping tool 50 has a head unit 60 and a carrier unit 80.

In an embodiment, the head unit 60 comprises a head assembly 62 and an arm assembly 64. For ease in positioning the head assembly 62 within a pipe 100, a preferred shape for the head assembly 62 may be a cylindrical shape. However, as the skilled person will appreciate, other shapes may be employed.

The head unit 60 of the line-stopping tool 50 disclosed herein may comprise more than one head assembly 62. In an embodiment, the head unit 60 comprises one, two or three head assemblies 62. When there are multiple head assemblies 62, the head assemblies 62 may be interconnected by any suitable means, such as a pivotal arm (e.g. yoke and yoke pin). In an embodiment, the head unit 60 comprises one or two head assemblies 62. In a preferred embodiment, the head unit 60 comprises only one head assembly 62, as shown in FIGS. 10-12.

Each head assembly 62 may, individually and independently, comprise 1, 2, 3, 4 or more seals. In an embodiment, each head assembly 62 has only one seal. In a preferred embodiment, each head assembly 62 has two seals. In an embodiment, the head unit 60 comprises only one head assembly 62 and the head assembly 62 comprises only two seals.

At least one seal of the line-stopping tool 50 is a seal 10 of the present disclosure. In an embodiment, at least one seal of each head assembly 62 is a seal 10 of the present disclosure. In an embodiment, at least two seals of each head assembly 62 are seals 10 of the present disclosure. In an embodiment, the line-stopping tool 50 comprises two head assemblies 62 and each head assembly 62 has one seal that is a seal 10 of the present disclosure. In an embodiment, the line-stopping tool 50 comprises two head assemblies 62 and each head assembly 62 has two seals that are seals 10 of the present disclosure. In a preferred embodiment, the head unit 60 comprises only one head assembly 62 and the head assembly 62 comprises two seals 10 of the present disclosure, as shown in FIGS. 10-12.

Generally, in an embodiment such as shown in FIG. 12, the head assembly 62 comprises of a core 66, two seals 10, and opposing ends 68 (68a and 68b).

A purpose and function of the core 66 is to act as a platform for other components (e.g. seals 10, arm assembly 64, and opposing ends 68) to interface with, directly or indirectly, to assemble the head unit 60. The core 66 also serves to provide resistance to service loads when the line-stopping tool 50 is positioned in the pipe 100 and activated. Opposing ends 68 (68a and 68b) are positioned at each end of the head assembly 62. In an embodiment, the opposing ends 68 are of the same design.

As shown in FIGS. 11 and 12, core 66 and one of the opposing ends (68a or 68b), each function to contain a respective side of the seal 10 and act as a clamping surface to prevent leaks into and out of the head unit 60. As described above in relation to the seals 10, the seals 10 may comprise a lip 38 that interacts with a complementary surface on the core 66 and one of the opposing ends (68a or 68b) to assist in a tight sealing engagement of the seals 10 within the head unit 60 and to hold the seals 10 firmly in place within the head unit 60 upon activation. This design is particularly advantageous in containing the expansion medium 15 within the seal 10. Further still, the core 66 may internally house the fluid conduit 93 for providing expansion medium 15 to the seals 10 by fluid communication with the channels 30, thereby allowing for the sealing and lock-out functions of the seals 10.

As will be appreciated, each opposing end 68 may be slightly different in structure based on auxiliary features. For example, opposing end 68a may be of a structural design that is advantageous for interacting with the arm assembly 64 to allow for pivotal movement of the head unit 60 in relation to the carrier unit 80. Also, opposing end 68a may have a design that permits passage of the fluid conduit 93 components.

As another example, opposing end 68b may be of a structural design to allow for the mounting of a wheel assembly, such as shown in FIG. 10 as feature 70. In an embodiment, the wheel assembly 70 comprises a chassis 72 and one or more wheels 76, each wheel attached to the chassis 72 by an axle 74. The chassis 72 is of a suitable shape to allow the head unit 60 to rotate into position inside the pipe 100, including under no flow service conditions. The wheels 76 prevent the line-stopping tool 50 from rubbing on the wall of the pipe 100 during positioning, and to help the head unit 60 rotate into position inside the pipe, particularly under no flow service conditions. Other wheel assembly structures may also be employed and would be known to the skilled person. In a further embodiment described elsewhere herein, opposing end 68b may comprise a purge port 78 for purging undesired substances from the pipeline (e.g. by using nitrogen).

A purpose and function of the arm assembly 64 is to connect the head assembly 62 to the carrier unit 80 in a configuration to resist and transfer service loads. The arm assembly 64 may be of any suitable design to allow for pivotal positioning of the head unit 60 into the pipe 100 in relation to the carrier unit 80. In an embodiment, the arm assembly 64 has a smaller girth than the head assembly 62 to more readily permit pivotal movement of the head unit 60 into the pipe 100. By “smaller girth”, it is meant that the perimeter of the arm assembly 62 around its longitudinal axis is smaller than the perimeter of the head assembly 64 around its longitudinal axis. In an embodiment, the girth of the arm assembly 64 is smaller at the end that connects to the carrier unit 80 than at the end that connects to the head assembly 62. This design aids in making a 90° corner to position the head unit 60 within the pipe 100.

In an embodiment, the arm assembly 64 is a single piece and may be threaded onto the head assembly 62. In another embodiment, the arm assembly 64 is comprised of two separate longitudinal halves. This design may be advantageous for several reasons. For one, being comprised of two halves makes for easy attachment of the arm assembly 64 onto the core 60 of head assembly 62 and onto the carrier unit 80 via a pivot pin 82 that passes through respective holes on each half of the arm assembly 64. For another, being comprised of two halves allows for easy installation within the arm assembly 64 of fluid conduit components, if desired. In this regard, in an embodiment, the arm assembly 64 may comprise an access panel on its external surface with connectors in fluid communication with the fluid conduit components within the arm and head assemblies (62 and 64). The connectors may, for example be female connectors to receive male connectors from the fluid conduit components of the carrier unit 80, or vice versa. In an alternative embodiment, the access panel may be on the core 60 and the arm assembly may be open, exposing the access panel to the fluid conduit components of the carrier unit 80. In an embodiment, a suitable location for the access panel on the core 60 is shown by arrow 90 in FIG. 12 (see also FIG. 11).

An advantageous embodiment of the line-stopping tool 50 of the present disclosure is the inclusion of a knuckle 84 on the bottom side of the arm assembly 64. An exemplary embodiment of the knuckle 84 is shown in FIGS. 11 and 14-17. When the line-stopping tool 50 is being positioned within the pipe 100, the knuckle 84 is configured to abut against the wall at the bottom of the pipe 100 to align the seals 10 within the head unit 60 at a right angle to the pipe 100. The knuckle 84 centers the head assembly 62 inside the pipe such that the gap between the head assembly 62 and wall of the pipe 100 is substantially equivalent all the way around. The knuckle 84 also ensures that the head assembly 62 remains in this centered, right-angle position throughout the line isolation operations, irrespective of significant pipeline pressures and/or any changes in pipeline pressures.

In an embodiment, at least a portion of the knuckle 84 is positioned below the pivot pin 82 such that the knuckle 84 abuts the bottom of the pipe 100 below the pivot pin 82, as shown in FIG. 11. In this configuration, as pipeline pressure hits the head assembly 62 and slightly moves it downstream, the angles of the seals 10 in relation to the wall of the pipe 100 are not affected because the distance from the bottom of the pipe 100 to the center of the pivot pin 82 stays the same due to the presence of the knuckle 84 directly below the pivot pin 82.

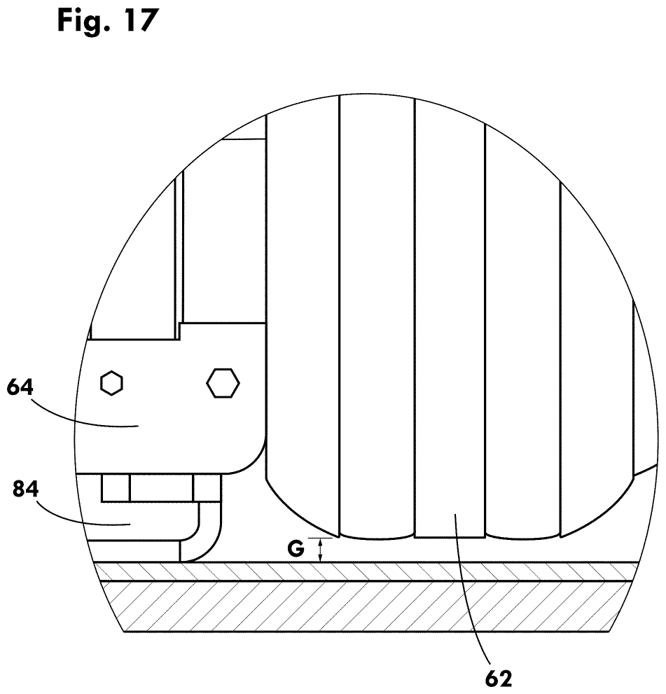

As will be appreciated, the size of the knuckle 84 will depend on the size of the pipe 100, head assembly 62 and arm assembly 64. In essence, the knuckle 84 holds the arm assembly 64 up in the pipe 100 so that that the head assembly 62 is centered. The knuckle 84 will therefore be of a size such that it extends downward from the arm assembly 64 past a position planar to the bottom of the head assembly 62 by a distance equivalent to the gap (G) between the head assembly 62 and the pipe 100. This is shown in exploded view in FIG. 17. The skilled person could readily perform the necessary calculations to determine the appropriate size of the knuckle for any given pipe 100, head assembly 62 and arm assembly 64. The knuckle should also be of a sufficient size that it does not damage or cause stress to the bottom of the pipe when the head unit is being positioned in the pipe.

In an embodiment, when the line-stopping tool 50 is positioned within the pipe 100, a bottom of the carrier unit 80 abuts the wall at the bottom of the pipe 100 in planar relationship with a bottom of the knuckle 84. By “planar relationship”, it is meant that a 2-dimensional flat surface is formed between the bottom of the carrier unit 80 and the bottom of the knuckle 84. In this configuration, the knuckle 84 does not alone bear all of the transfer service loads and operating pressures to maintain the head assembly in position. Rather, the carrier unit 80 also assists in positioning and maintaining the head assembly at a centered, right-angle position.

In an embodiment, the bottom of the carrier unit 80 and the bottom of the knuckle 84 may have a curvature complementary to the bottom of the pipe 100. This curvature will further assist in proper alignment of the head assembly 62 within the pipe. As opposed to top-bottom alignment, the complementary curvature will aid in centralizing the head assembly 62 in the pipe in a left-right orientation. The complementary curvatures also ensure that the head assembly 62 remains in its centered, right-angled position throughout the line isolation operations, irrespective of significant pipeline pressures and/or any changes in pipeline pressures.

The head unit 60 is pivotally connected to a carrier unit 80. Referring again to FIGS. 10-12, an exemplary embodiment of the carrier unit 80 is shown having a body 86 and a pivot pin 82. A purpose of the carrier unit 80 is to connect the line-stopping tool 50 to a means for moving the tool into and out of the pipe. In an embodiment, the means for moving the tool is a ram. In a more particular embodiment, the means is a hydraulic cylinder ram. The body 86 of the carrier unit 80 is of a design to resist and transfer service loads and protect fluid conduit 93 components. In an embodiment, the fluid conduit 93 components are housed within and pass through an internal bore of the carrier unit 80.

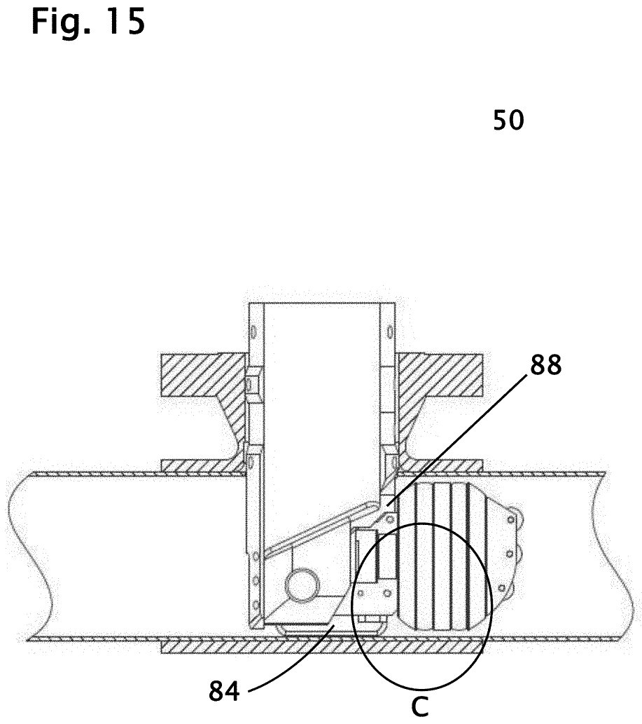

In an advantageous embodiment of the line-stopping tool 50 of the present disclosure, the body 86 of the carrier unit 80 has a locator surface 88. As shown in FIG. 15, the locator surface 88 can be designed to be complementary to a surface on the arm assembly 64 such that when the line-stopping tool 50 is positioned within the pipe 100, the locator surface acts as a barrier preventing the head assembly 62 from rotating past 90°. Thus, the locator surface 88 is another means to ensure that the head assembly 62 is centered within the pipe 100, and remains centered throughout the line isolation operations, irrespective of significant pipeline pressures and/or any changes in pipeline pressures.

As shown in the exemplary embodiments in FIGS. 12-16, the carrier unit has a pivot pin 82 to provide the pivot means. The skilled person will appreciate that other pivot means are available and could be used in place of a pivot pin 82. The purpose of the pivot means is to secure the carrier unit 80 to the head unit 60, resist and transfer service loads, and allow the head unit 60 to rotate relative to the carrier unit 80. Other pivot or rotational means that provide these purposes may alternatively be used.

In other embodiments, the carrier unit 80 may further comprise transfer components 92. The transfer components 92 may be fitted to the sides of the carrier unit 80 to act as load bearing surfaces to transfer service loads onto the line-stopping tool 50. The transfer components 92 also serve a function of securing the line-stopping tool 50 parallel within the access pipe. The size of the transfer components 92 may be adjusted, and different sizes fitted to the carrier unit 80, depending on the diameter of the access pipe.

As shown in an exemplary embodiment in FIG. 11, the line-stopping tool 50 of the present disclosure comprises a fluid conduit 93 in fluid communication with the channels 30 within the seals 10. The fluid conduit 93 is configured for providing an expansion medium 15 to the seals 10. At least when in operation (e.g. seal activation), the fluid conduit 93 is in fluid communication with a source of an expansion medium 15. In an embodiment, the fluid conduit 93 is internal to the head unit 60 and carrier unit 80. In some embodiments, the fluid conduit 93 is external at one or more points between the seals 10 and the top of the carrier unit 80. As an example, the fluid conduit 93 may be external to the line-stopping tool 50 at the junction between the head unit 60 and the carrier unit 80, such as described above in respect of an access panel on the arm assembly 64 or the core 66.

The source of the expansion medium 15 may be any one or more of a hydraulic system, a compressor, a pump or any other suitable means of providing an expansion medium 15 to the seals 10 at a sufficient pressure to activate (i.e. expand) the seals 10. In an embodiment, the source of the expansion medium 15 is a hydraulic system. The expansion medium 15 may be any fluid or gas that is compatible with the seals 10 and is capable of providing sufficient pressure to activate the seals, maintain such activation, and be de-activated by withdrawing the expansion medium 15. In an embodiment, the expansion medium 15 is a hydraulic fluid. The skilled person could select an appropriate hydraulic fluid. Desirable characteristics of the hydraulic fluid are non-compressible, fast release, low foaming tendency, low volatility, good fluidity, high viscosity index to minimize internal leakage, and biodegradable. In an embodiment, the hydraulic fluid is made from a mineral oil base, a synthetic hydrocarbon base, or a phosphate-ester base.

The fluid conduit 93 forms a passageway from the source of the expansion medium 15 to the head assembly 62. In an embodiment, the fluid conduit 93 is a tubing or other supply line that runs from the source of the expansion medium 15 to the head assembly 62 where there is fluid communication with the seal 10. Typically, the source of the expansion medium 15 will be external to the line-stopping tool 50. Thus, in some embodiments, an external supply line is part of the fluid conduit 93 described herein. The fluid conduit 93 may include any number of fittings, connectors and tubing/lines. In an embodiment, the fluid conduit 93 is a braided or non-braided hose or tubing, or any combination thereof.

An advantageous aspect of the line-stopping tool of the present disclosure is that each seal 10 in the head unit 60 can be activated and de-activated separately. In such embodiments, the fluid conduit 93 will include a separate conduit or passageway for each seal 10. Thus, in an embodiment, the fluid conduit 93 comprises a first fluid conduit 93a configured for providing the expansion medium 15 to the channels 30 of one seal 10 (first seal) and a second fluid conduit 93b configured for providing the expansion medium 15 to the channels 30 of another seal 10 (second seal). Each of the first fluid conduit 93a and the second fluid conduit 93b will use separate and independent conduits or passageways. Moreover, in embodiments where the expansion medium 15 is provided by a hydraulic system, each of the first and second fluid conduits (93a and 93b) will use separate hydraulic systems.

In an embodiment, the fluid conduits 93 may be in fluid communication with the channels 30 of the seals 10 by direct attachment to the channels 30. For example, the first port 32 may be a threaded port to which the supply line of the fluid conduit 93 can attach. In another embodiment, the fluid conduits 93 may provide fluid communication with the channels 30 of the seals 10 by alternate means. For example, the supply line of the fluid conduit 93 may deliver the expansion medium 15 to the groove 36 within the bore of the inner ring 12. The expansion medium 15 will fill the groove 36 and deliver the expansion medium 15 through each first port 32 disposed therein. The latter embodiment of delivery to groove 36 may be advantageous in its simplicity of design and in providing a more uniform delivery of expansion medium 15 to each channel 30 of the seal 10, e.g. regardless of the rotation of the seal 10 on the core 66.

As the skilled person will appreciate from the above, the fluid conduit 93 is a continuous passageway from the source of the expansion medium 15 to the seal 10. Because of this arrangement, an expansion medium 15 may pass from the source of the expansion medium 15 to the seal 10, thereby causing the seal 10 to expand from a retracted position to an expanded position. In the expanded position, the seal 10 will engage the wall of the pipe 100. The line-stopping tool 50 of the present disclosure does not rely at all on pipeline pressure to activate the seal. Moreover, as described elsewhere herein, control systems for the line-stopping tool 50 of the present disclosure allow for continued monitoring of the seal pressure, hydraulic pressure, upstream pipeline pressure, and downstream isolation pressure, and also allow for continuous bleed and bleed monitoring, as well as performing a downstream purge.

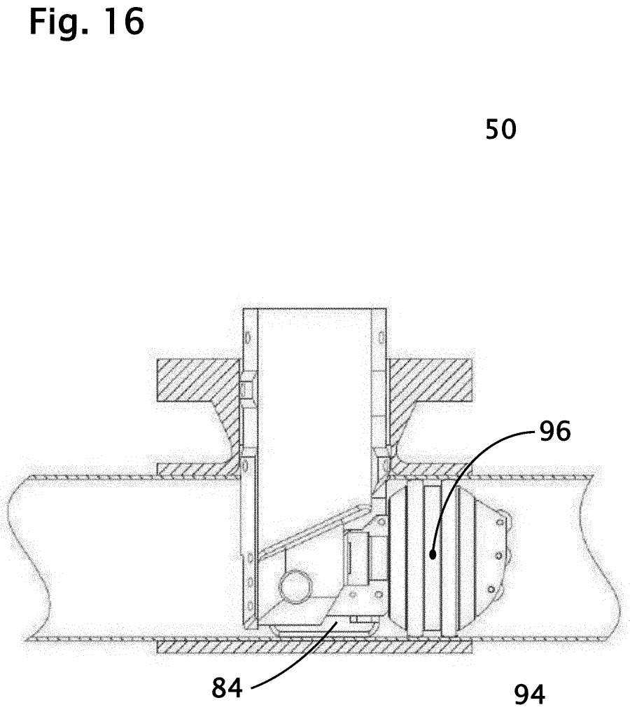

In addition to the fluid conduit 93 that communicates with the seals 10, the line-stopping tool 50 of the present disclosure may further comprise a pressurization conduit 95, for example as shown in FIG. 11. The pressurization conduit 95 is a passageway between an external pressurization source and an interior space of the pipe 100 located between two seals 10 in the head assembly 62. This interior space is indicated by arrow 94 in FIGS. 11 and 16. In an embodiment, the pressurization conduit 95 is in fluid communication with a pressurization port 96 located at an external surface of the head assembly 62 between two seals 10. The pressurization port 96 is open to the interior space (arrow 94) between the seals 10.

The pressurization conduit 95 may be of a similar construction as the fluid conduit 93 described above. In particular, the pressurization conduit 95 is a continuous passageway from a pressurization source to the interior space of the pipe between the seals 10. Because of this arrangement, a pressurization medium (e.g. fluid or gas) may be delivered from a source of the pressurization medium to the interior space of the pipe between the seals 10. The pressurization medium may be the same or different than the expansion medium 15, and may be delivered by any suitable means (e.g. a hydraulic system, a compressor, a pump or otherwise). An advantageous function of the pressurization conduit 95 is the ability to pressure test (leak test) the seals 10 to verify that each seal 10 is properly set against the pipe 100. In an embodiment, this is done by pressurizing the interior space of the pipe between the seals to determine if the seals can hold the pressure, thereby verifying that the seals are properly set.

To provide a DBB line-stopping tool, the pressurization conduit 95 also provides a second function of acting as the bleed. The pressurization conduit 95 can continuously bleed substances (fluid and/or gas) from the interior space between the seals 10 via the pressurization port 96. In operation, the pressurization conduit 95 may be left open and monitored for flow. In alternative embodiments, the pressure within the interior space of the pipe between the seals 10 may be monitored. A sudden spike in pressure may be indicative of a seal leak and the pressurization conduit 95 would be used to bleed pressure and/or fluid from the interior space. In an embodiment, this process could be automated such that if the system detects a spike in pressure, a release valve is opened to bleed the pressure and/or fluids. Alternatively, the process could be manual requiring the physical interaction of an operator. Depending on the product within the pipeline, the bleed could be vented or drained to a reservoir or to ambient.

In a further advantageous embodiment, the line-stopping tool 50 of the present disclosure may include a check valve 97 within the tool. In a preferred embodiment, the check valve 97 is in the head assembly 62 in close proximity to the seals 10. In a preferred embodiment, there is a separate check valve 97 for each seal 10 so that each seal 10 can be independently controlled.

Check valves are well-known in the art and the skilled person could select an appropriate check valve for any particular application of the line-stopping tool 50 of the present disclosure, depending on certain variables such as seal pressurization levels and pipeline operating pressures. Importantly and uniquely, the check valve 97 may be placed within the head assembly 62 of the line-stopping tool 50 disclosed herein. The purpose of the check valve 97 is to act as a one-way valve for the expansion medium 15. In the event of a leak or failure in the fluid conduit 93, the check valve 97 will not allow the expansion medium 15 to escape from the seal 10. This will prevent any leakage from seal 10 past the check valve 97 and will greatly reduce the likelihood of a catastrophic seal failure. It is a significant advantage for the check valve 97 to be in the head assembly 62, rather than external to the tool, because this reduces the risk of complete seal failure by localizing events within the head assembly 62. A check valve 97 located external to the tool means that any expansion medium 15 in the seal 10 would escape to a more distal location, resulting in a greater extent of seal failure.

In a further embodiment, the check valve 97 would be of a design so as to have an over-pressure relief. In operation, if the pressure from the seal 10 on the check valve 97 exceeds a predetermined value, the check value 97 would allow for the release of expansion medium 15 from the seal 10 to attain the desired pressure. This feature may be particularly useful in operating conditions that are subject to fluctuations in temperature since changes in temperature may result in changes in pressure within the seals 10.

Because the seals 10 of the present disclosure are capable of being de-activated, embodiments of the line-stopping tool 50 that include a check valve 97 should also include a means to release the check valve 97 to allow the expansion medium 15 to be withdrawn from the seal 10. Any suitable means may be used. In an embodiment, this may be achieved by a rod and piston setup. The rod can release the check valve 97 by pressing on a spring-loaded sealing disk. The rod can be operated and connected at one end by a piston. When a releasing load is applied to the piston by a hydraulic pressure, the piston moves the rod to release the check valve 97. As shown in FIG. 11, the line-stopping tool of the present disclosure may include check valve conduits 99 for the delivery of pressure (e.g. hydraulic pressure) to open the check valve 97.

In a further embodiment, the line-stopping tool 50 of the present disclosure may include a gas vent passageway configured to relieve upstream gas pressure when the line-stopping tool is positioned within an operational pipeline. In an embodiment, the gas vent passageway is a feature of the carrier unit 80. For example, in an embodiment the carrier unit 80 may have a recess in its external profile so as to create an opening or gap between the carrier unit 80 and the access pipe in which the carrier unit 80 sits when the line-stopping tool is positioned within a pipeline. This recess can be seen in FIG. 10 by feature 103. In another embodiment, the carrier unit 80 may have an internal channel to act as a gas relief passageway. In some embodiments, the gas relief passageway may be used to carry or transfer pipeline payloads to an alternate (e.g. temporary) pipeline to bypass the isolated section of pipe.

In a further embodiment, the line-stopping tool 50 of the present disclosure may include a purge conduit 101 in fluid communication with a purge port 78 located at a downstream end of the head unit 60. In an embodiment, the purge conduit is for purging hazardous substances from the isolated section of pipe. In an embodiment, the purge may be performed using nitrogen, e.g. by delivering nitrogen to the isolated section of pipe through the purge conduit and thereby forcing substances within the pipeline downstream.

In a further embodiment, the line-stopping tool 50 of the present disclosure may include one or more magnets on or within the head unit 60. The function of the magnets is to capture metal filings and/or debris from the hot-tap procedure. In an embodiment, the magnets may be positioned on opposing end 68b. Other means of capturing debris from in front of the head unit 60 may also be used.

The line-stopping tool 50 of the present disclosure is of an advantageous design, having improved seals 10 and several unique features that allow for easy and proper alignment of the head assembly 62 within the pipe 100. In this regard, the knuckle 84 and locator surface 88 are particularly beneficial features.

As will be described further below, methods of employing the line-stopping tool 50 of the present disclosure are also improved in comparison to other available tools, which are more complex and may not meet the full criteria of a DBB isolation system.

### Methods

In another aspect, the present disclosure provides methods for isolating a section of a pipe. By “isolating a section of pipe”, it is meant plugging or sealing off a section of pipe such that pipeline products (fluids, gases or other substances) are prevented from entering the isolated section. In an embodiment, the section of pipe may be isolated from both sides by employing a line-stopping tool 50 at each end of the isolated section. This would involve two line-stops and, as discussed above, the pipeline payload could be transferred to an alternate (e.g. temporary) pipeline to bypass the isolated section. In another embodiment, the section of pipe may be isolated at only one end of the section of pipe, typically the side from which the pipeline products flow.

As used herein, “isolating” may be used interchangeably with “stopping”. Thus, reference herein to a “line-stopping tool” is equivalent to a “line-isolation tool”. Both terms mean a tool for plugging or sealing off a section of pipe.

Although the line-stopping tool 50 may be used for lengthy periods of time to isolate a section of pipe, the methods disclosed herein are typically for temporary isolation a section of pipe, e.g. while maintenance or other activities are performed downstream of the line-stopping tool 50.

Line-stopping will now be described further with reference to FIGS. 12-16. In use, a line-stop is performed by any appropriate method by employing a line-stopping tool with a head unit comprising at least one seal 10 of the present disclosure.

In an embodiment, the method of isolating a section of a pipe comprises the steps of: inserting a head unit into a pipe, the head unit comprising at least one seal configured to engage the wall of the pipe, wherein the at least one seal comprises: (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring, and providing an expansion medium to the at least two seals via a fluid conduit in fluid communication with the at least one channel of each of the at least two seals, to sealingly engage the at least two seals against the pipe and thereby isolate a section of the pipe. In an embodiment, the head unit comprises at least two seals. In an embodiment, the head unit is inserted into the pipe through an opening in the wall of the pipe.

In an embodiment, the method of isolating a section of a pipe comprises the steps of: inserting a head unit into a pipe, the head unit comprising at least one seal configured to engage the wall of the pipe, wherein the at least one seal comprises: (i) a ring defining a bore and having a width and a thickness, the ring having one or more holes spanning the width and open to both a first and second side of the ring; (ii) at least one channel configured for providing fluid communication between the bore of the ring and an exterior surface of the ring outside the bore; and (iii) an expandable material covering at least the surfaces of the ring outside the bore, the expandable material forming a seal ring extending around and outwardly from an outer circumference of the ring, and providing an expansion medium to the at least two seals via a fluid conduit in fluid communication with the at least one channel of each of the at least two seals, to sealingly engage the at least two seals against the pipe and thereby isolate a section of the pipe. In an embodiment, the head unit comprises at least two seals. In an embodiment, the head unit is inserted into the pipe through an opening in the wall of the pipe.

The methods herein involve inserting a head unit with at least one seal 10 into a pipe 100, such as for example through an opening in a wall of the pipe. In an embodiment, the head unit may be head unit 60 of the line-stopping tool 50 of the present disclosure. In an embodiment, the head unit comprises two of the seals 10. In an alternative embodiment, a different line-stopping tool may be used, adapted to use one or more seals 10 of the present disclosure.

A hot-tap may be performed as is well-known in the art. In an exemplary hot-tap procedure, an access connection 98 (e.g. flanged saddle) is fitted to a live pipe 100. A temporary valve and access pipe (not shown) may be bolted to the access connection 98. The temporary valve prevents leakage from the live pipe after tapping (e.g. drilling) into the pipe. The tapping tool itself is likewise configured to prevent leakage during pipe cutting and upon removal the temporary valve is closed to complete the branch connection.

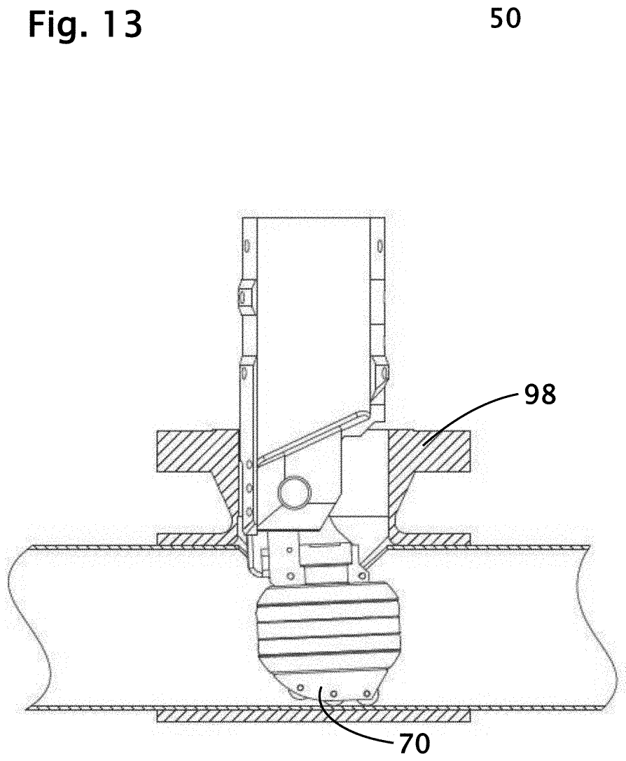

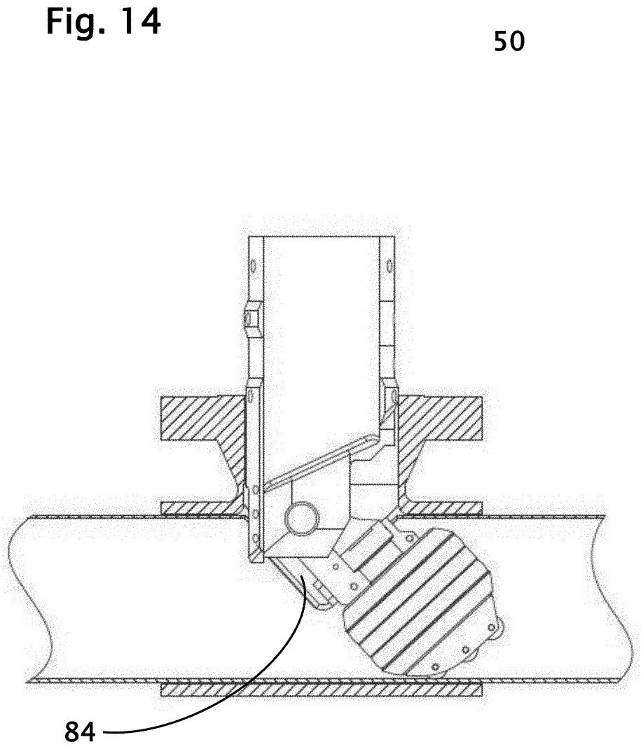

After the hot-tap, and referring to the embodiments shown in FIGS. 12-16, line-stopping tool 50 travels downwardly through access connection 98 until wheel assembly 70 on the head unit 60 contacts a bottom portion of the pipe 100 (FIG. 13). When traveling down the access pipe (not shown), the carrier unit 80 and head unit 60 are aligned substantially longitudinally with each other. The seals 10 are in a de-activated (retracted) state. As the line-stopping tool 50 is advanced down the access pipe and through the access connection 98, contact between the wheel assembly 70 and the wall of the pipe causes the head unit 60 to pivot about the carrier unit 80 (FIG. 14).

Downward transfer service (e.g. by a hydraulic cylinder ram) continues from above and soon the knuckle 84 abuts against the bottom of the pipe 100 (FIG. 15). As described elsewhere herein, the knuckle 84 serves a valuable function in aiding in the centering of the head assembly 62 within the pipe 100. In an embodiment, the bottom of the knuckle may have a curvature complementary to the wall of the pipe 100 to further assist in centering the head assembly 62 in the pipe 100.

With the head assembly 62 positioned and aligned within the pipe 100, the seals 10 may be activated by providing an expansion medium 15 through a fluid conduit 93 that is in fluid communication with channels 30 in the seals 10. In an embodiment, the expansion medium 15 is a hydraulic fluid and the hydraulic fluid is provided to the seals 10 by a hydraulic system that is interconnected with the fluid conduit 93. In a preferred embodiment, a separate fluid conduit 93 communicates with each seal 10 such that each seal 10 can be independently activated. The delivery of expansion medium 15 to the seals 10 causes the seal ring 26 to expand radially outwards and engage the walls of the pipe 100 (FIG. 16).

When the head unit comprises two or more seals 10, the seals 10 may be activated at the same time, sequentially or in an alternating pattern of partially activating one and then the other until each of the seals is fully activated. The skilled person will appreciate that any order and combination of steps may be used to activate the seals 10. In an embodiment, the most upstream seal 10 is activated first and after it has engaged the wall of the pipe 100, a second downstream seal 10 on the head unit 60 is activated. This order of activation may be preferred when the line-stopping tool 50 is positioned in an operational pipeline. In an alternate embodiment, both of the seals 10 are activated simultaneously to engage the pipe 100. This simultaneous mode of activation may be preferred in pipelines that are not operational when the line-stopping tool 50 is installed. In an alternate embodiment, the seals 10 are activated in a “walked-up” or “step-wise” fashion, meaning that each seal 10 is expanded gradually, alternating between the seals 10 with incremental increases in the delivery of expansion medium 15 to each seal 10 at each step.

In the methods disclosed herein, the step of activating the seals 10 by providing expansion fluid may be repeated at any time for any one or more of the seals 10 in any order. This step may be performed to maintain the sealing engagement of the seal 10 against the wall of the pipe 100 if an insufficient sealing engagement is observed at any time during operation of the line-stopping tool 50. This step may also be performed if it desired to de-activate and re-activate the seal 10 at any time during operation. For instance, it may be desirable to move the line-stopping tool within the pipe 100 or to allow pipeline products to flow past the seal to test repairs on the downstream isolated section.

Since activation of the seals 10 occurs within the enclosed pipe 100, it is difficult to visually observe if the seals 10 have properly engaged the wall of the pipe 100. In an advantageous embodiment of the present disclosure, the line-stopping tool 50 may further comprise a pressurization port 96 and pressurization conduit 95 in fluid communication therewith, as described elsewhere herein. The pressurization conduit 95 may be used to pressurize an interior space (indicated by arrow 94 in FIG. 16) of the pipe 100 located between two seals 10. This provides a means of testing the seals 10. Pressurized gas or fluid may be provided to the interior space, thereby pressurizing the interior space. If the pressurization can be maintained within the interior space between the seals 10, this confirms that the seals 10 have been activated and have properly engaged the wall of the pipe 100.

As described elsewhere herein, the pressurization conduit 95 can serve a dual function of acting as a bleed. Thus, in further embodiments of the methods disclosed herein, the pressurization conduit 95 may be used to bleed pressure and/or fluid from the interior space of the pipe between the seals 10. This may be done for several reasons. Firstly, in the event of a seal failure and leak of pipeline products into the interior space between the seals, the pressurization conduit 95 may be used to bleed the pipeline products and pressure therefrom. In such embodiments, the line-stopping tool 50 disclosed herein functions as a DBB line-stopping tool. Secondly, in some embodiments, it may be desirable to create a negative pressure within the interior space by bleeding pressure therefrom.

To achieve these functions of the pressurization conduit 95 acting as a bleed, it may be desirable to include a valve along the pressurization conduit 95, either within the line-stopping tool 50 or external to the tool. The valve would provide a means of isolating and maintaining pressure within the interior space, and controlling any leakage out of the bleed.

In various aspects, the methods disclosed herein may include steps of monitoring the functioning of the line-stopping tool 50, and more particularly the seals 10 therein. In an embodiment, the step of monitoring includes monitoring the pressure of various components of the line-stopping tool 50 and/or within the pipe 100, including without limitation:

(i) the pressure within a first seal 10 within the head unit 60, the first seal being on the operational side of the head unit 60;

(ii) the pressure within a second seal 10 within the head unit 60, the second seal being on the isolated side of the head unit 60;

(iii) the pressure within the interior space between two activated seals 10;

(iv) the pressure at the check valves 97 that are in fluid communication with the seals 10;

(v) the pressure upstream of the line-stopping tool 50 (i.e. on the operational, non-isolated side of the tool); and

(vi) the pressure downstream of the line-stopping tool 50 (i.e. on the isolated side of the tool) via the purge conduit 101.

The pressures above may be monitored at any time during placement of the line-stopping tool 50 within the pipe, or may be monitored continuously or intermittently after activation. In an embodiment, the pressure within each of the seals 10 is monitored during activation and intermittently thereafter. In some embodiments, the pressure within the seals 10 is monitored continuously after activation. In some embodiments, the pressure within the interior space between the two activated seals is monitored continuously.

At times during operation of the line-stopping tool 50, it may also be desirable to vent gases and pressure build-up from the upstream side of the tool 50. As described elsewhere herein, in some embodiments the line-stopping tool 50 herein may include a gas vent passageway. Thus, in some embodiments, the methods herein may further comprise a step of venting a gas pressure from upstream of the head unit 60 via a gas vent passageway in the carrier unit 80.

On completion of the line isolation operation, the seals 10 of the line-stopping tool 50 may be de-activated by releasing or withdrawing the expansion medium 15 from the seals 10. In an embodiment, this is performed using a hydraulic system to remove a hydraulic fluid expansion medium 15 from the seals 10. Upon removal of the expansion medium 15, the seals 10 will retract and the line-stopping tool 50 can be pulled to the surface. Given the hardness of the expansion material 18 used for the seals 10 it may be desirable to leave to line-stopping tool 50 within the pipe 100 for a short period of time after removal of the expansion medium 15 to give the seals 10 time to retract back within the head assembly 62. In an embodiment, to aid in prompt retraction of the expandable material 18, seal spring 20 may be included in the seal 10 as described above. The inclusion of seal spring 20 will assist in retraction of the expandable material 18 due to the retention force of the seal spring 20.

It will be apparent to those skilled in the art that an embodiment of the line-stopping tool 50 of the present disclosure provides two bi-directional seals 10 within a single head unit 60, and thus provides for a double-block and bleed of a pipe in a single intervention. This serves to reduce operation time and cost involved with isolating a section of pipe. While the term “upstream” has been used generally throughout to refer to the operational side of the site of isolation (i.e. the side where pipeline products would be present), it is possible that the line-stopping tool 50 of the present disclosure could be used in the alternate orientation. Likewise, the term “downstream” has been used to refer to the isolated side of the site of isolation, this side could likewise have pipeline products therein at any given time during operation.

It will also be apparent to those skilled in the art that while exemplary methods and steps have been described, the line-stopping tool 50 and seals 10 of the present application are of broad application in providing hot-tapping and subsequent line-stopping services, and the skilled person would appreciate other uses and methods for employing the line-stopping tools 50 and seals 10 disclosed herein.

The term “upstream” is used generally throughout the present disclosure to refer to the operational side of the line-stopping tool 50 or the site of isolation (i.e. the section of pipe where pipeline products would be and remain present). The term “downstream” is used generally throughout the present disclosure to refer to the isolated side of the line-stopping tool 50 or site of isolation (i.e. the section of pipe to be isolated or that is isolated). The line-stopping tool 50 is bi-directional and it is contemplated that either end of the head unit 60 could be the upstream or downstream end, and that this could change at any time.

### Exemplary Embodiments

The following are non-limiting embodiments of the seals, line-stopping tools, and methods disclosed herein:

[1] A seal for a line-stopping tool, the seal comprising: an inner ring disposed within an outer ring in a coaxial arrangement and defining an annular space therebetween; at least one bridge member spanning the annular space and connecting the inner ring to the outer ring; at least one channel configured for providing fluid communication between a bore defined by the inner ring and an exterior surface of the outer ring; and an expandable material surrounding the outer ring and forming a seal ring extending around and outwardly from an outer circumference of the outer ring.

[2] The seal of [1], wherein the inner ring, the outer ring and the at least one bridge member are metal or a metallic alloy.

[3] The seal of [1] or [2], wherein the inner ring, the outer ring and the at least one bridge member are a monolithic structure.

[4] The seal of any one of [1] to [3], wherein the expandable material has a Scale A Shore Durometer of between about 75° Sh and about 100° Sh.

[5] The seal of any one of [1] to [4], wherein the expandable material has a modulus of elasticity of between about 2500 psi and about 7500 psi.

[6] The seal of any one of [1] to [5], wherein the expandable material is polyurethane 90A.

[7] The seal of any one of [1] to [6], wherein the expandable material fills the annular space and covers each of the at least one bridge member and the inner ring outside the bore.

[8] The seal of any one of [1] to [7], wherein the expandable material forms a lip extending longitudinally outward from each side of the inner ring, each lip encircling and further defining the bore.

[9] The seal of any one of [1] to [8], wherein the expandable material forms a shoulder on each side of the seal.

[10] The seal of [9], wherein the shoulder comprises a shoulder spring.

[11] The seal of any one of [1] to [10], wherein the seal ring is concentric with the inner ring and the outer ring and in radial cross-section the expandable material extending around and outwardly from the outer circumference of the outer ring is thicker than the expandable material on each side of the outer ring.

[12] The seal of any one of [1] to [11], wherein the at least one bridge member is 2, 3 or 4 bridge members.

[13] The seal of [12], wherein bridges members are equidistant from each other in the annular space.

[14] The seal of any one of [1] to [13], wherein each of the at least one channels individually comprises: (i) a first port on a surface of the bore of the inner ring, (ii) a second port on the exterior surface of the outer ring, and (iii) a passageway therebetween through the inner ring, one of the at least one bridge members, and the outer ring.

[15] The seal of [14], wherein the inner ring comprises a groove extending around a wall of the inner ring defining the bore, wherein the first port of each of the at least one channels is within the groove.

[16] The seal of [14] or [15], wherein the second port on the exterior surface of the outer ring is at a position most radially outwards from the co-axis of the inner and outer ring.

[17] The seal of any one of [1] to [16], wherein in radial cross-section the inner ring is a trapezoid shape with each parallel side being a base, and the shorter base defining the bore of the inner ring.

[18] The seal of any one of [1] to [17], wherein in radial cross-section the outer ring is a circular, an oval, an oblong, or a rounded rectangle shape.

[19] The seal of any one of [1] to [18], further comprising a circular seal spring within the seal ring that is in co-axial arrangement with the seal ring.

[20] The seal of [19], wherein the seal ring has a front side and a back side and the circular seal spring is at a position most radially outwards and at the back side within the seal ring, wherein when the seal is in a line-stopping tool the back side is oriented downstream of a pipeline operating pressure.

[21] The seal of any one of [1] to [20], wherein, when an expansion medium is provided to the exterior surface of the outer ring via one or more of the at least one channels, the expandable material expands from a retracted position to an expanded position.

[22] A line-stopping tool for plugging a pipe, the line-stopping tool comprising: a head unit configured for location in a section of a pipe, the head unit comprising at least one seal configured to engage the wall of the pipe to plug the section of the pipe, wherein the at least one seal comprises: (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring; a carrier unit having a pivotal connection to the head unit; and a fluid conduit in fluid communication with one or more of the at least one channels, and configured for providing an expansion medium to the at least one seal.

[23] The line-stopping tool of [22], wherein the head unit is configured for location in the section of the pipe through an opening in the wall of the pipe.

[24] The line-stopping tool of [22] or [23], wherein the head unit comprises two of the at least one seals.

[25] The line-stopping tool of [24], wherein the fluid conduit comprises: a first fluid conduit configured for providing the expansion medium to the at least one channel of a first seal of the two seals; and a second fluid conduit configured for providing the expansion medium to the at least one channel of a second seal of the two seals.

[26] The line-stopping tool of [25], wherein the first fluid conduit and the second fluid conduit are in fluid communication with the at least one channel of the first and second seals, respectively, via a groove extending around a wall of the inner ring defining the bore of each seal.

[27] The line-stopping tool of [25] or [26], further comprising a pressurization conduit in fluid communication with a pressurization port located at an external surface of the head unit between the first seal and the second seal, the pressurization port open to an interior space of the pipe.

[28] The line-stopping tool of [27], wherein, when the first and second seals are engaged against the wall of the pipe, the pressurization conduit is configured to (i) pressurize the interior space to test for a sealing engagement of the first and second seals, and (ii) bleed pressure and/or fluid from the interior space in the event of a seal leak.

[29] The line-stopping tool of [27] or [28], wherein the first and second fluid conduits and the pressurization conduit are a braided or non-braided hose or tubing, or any combination thereof.

[30] The line-stopping tool of any one of [22] to [29], wherein the head unit comprises an arm assembly and a head assembly with the at least one seal being on the head assembly, the arm assembly having a smaller girth than the head assembly for pivotal location of the head assembly in the pipe, and the arm assembly comprising a knuckle configured to abut against the wall at a bottom of the pipe and center the head assembly within the pipe when the line-stopping tool is positioned within the pipe.

[31] The line-stopping tool of [30], wherein, when the line-stopping tool is positioned within the pipe, a bottom of the carrier unit abuts the wall at the bottom of the pipe in planar relationship with a bottom of the knuckle.

[32] The line-stopping tool of [31], wherein the bottom of the knuckle and the bottom of the carrier unit have a curvature complementary to the curvature of the bottom of the pipe.

[33] The line-stopping tool of any one of [22] to [32], further comprising a check valve in the head unit configured for maintaining an expansion pressure in the at least one seal.

[34] The line-stopping tool of any one of [22] to [33], wherein the carrier unit further comprises a gas vent passageway configured to relieve gas pressure from upstream of the line-stopping tool when the line-stopping tool is positioned within the pipe.

[35] The line-stopping tool of any one of [22] to [34], further comprising a nitrogen purge conduit in fluid communication with a purge port located at a downstream end of the head unit and open to an isolated section of pipe when the line-stopping tool is positioned within the pipe.

[36] The line-stopping tool of any one of [22] to [35], wherein, when the line-stopping tool positioned within the pipe and when expansion medium is provided to each seal of the at least one seal, the expandable material expands from a retracted position to an expanded position to engage the wall of the pipe.

[37] A method of isolating a section of a pipe, the method comprising the steps of: inserting a head unit into a pipe, the head unit comprising at least one seal configured to engage the wall of the pipe, wherein the at least seal comprises: (i) an inner ring disposed within an outer ring in a coaxial arrangement and defining an annular space therebetween; (ii) at least one bridge member spanning the annular space and connecting the inner ring to the outer ring; (iii) at least one channel configured for providing fluid communication between a bore defined by the inner ring and an exterior surface of the outer ring; and (iv) an expandable material surrounding the outer ring and forming a seal ring extending around and outwardly from an outer circumference of the outer ring, and providing an expansion medium to the at least one seal via a fluid conduit in fluid communication with the at least one channel of the at least one seal, to sealingly engage the at least one seal against the pipe and thereby isolate a section of the pipe.

[38] The method of [37], wherein the head unit is configured for insertion into the pipe through an opening in the wall of the pipe.

[39] The method of [37] or [38], wherein the head unit comprises two of the at least one seals.

[40] The method of [39], further comprising a step of pressurizing an interior space of the pipe located between the two seals via a pressurization conduit in fluid communication with a pressurization port located at an external surface of the head unit and open to the interior space.

[41] The method of [39], further comprising bleeding pressure and/or fluid from an interior space of the pipe located between the two seals via a pressurization conduit in fluid communication with a pressurization port located at an external surface of the head unit and open to the interior space.

[42] The method of any one of [39] to [41], wherein the step of providing the expansion medium to the two seals independently comprises, in any order or at the same time: providing the expansion medium to a first seal of the two seals via a first fluid conduit in fluid communication with the at least one channel of the first seal; and providing the expansion medium to a second seal of the two seals via a second fluid conduit in fluid communication with the at least one channel of the second seal.

[43] The method of any one of [37] to [42], further comprising a step of monitoring a pressure of the at least one seal at any time, or continuously, after providing the expansion medium.

[44] The method of any one of [37] to [43], wherein the step of providing the expansion medium to the at least one seal is repeated, independently for each seal, at any time to maintain sealing engagement against the wall of the pipe.

[45] The method of any one of [37] to [44], further comprising a step of pressurizing a check valve within the head unit, via a check valve pressurization channel, to release some or all of the expansion medium from the at least one seal, wherein the check valve is configured to maintain the at least one seal in sealing engagement against the wall of the pipe in the event of a seal leak.

[46] The method of any one of [37] to [45], wherein the step of inserting the head unit into the pipe comprises lowering the head unit through an access pipe to an opening in the wall of the pipe.

[47] The method of [46], wherein the head unit is lowered into the opening on a carrier unit, the head unit comprising an arm assembly and a head assembly with the each of the at least one seal being on the head assembly, wherein the carrier unit is pivotally connected to the arm assembly and the arm assembly has a smaller girth than the head assembly.

[48] The method of [47], wherein the carrier unit is lowered into the opening until a knuckle on the arm of the head unit contacts the wall at a bottom of the pipe.

[49] The method of [47] or [48], further comprising a step of venting a gas pressure from upstream of the head unit within the pipe via a gas vent passageway in the carrier unit.

[50] A seal for a line-stopping tool, the seal comprising: a ring defining a bore and having a width and a thickness, the ring having one or more holes spanning the width and open to both a first and second side of the ring; at least one channel configured for providing fluid communication between the bore of the ring and an exterior surface of the ring outside the bore; and an expandable material covering at least the surfaces of the ring outside the bore, the expandable material forming a seal ring extending around and outwardly from an outer circumference of the ring.

[51] The seal of [50], which comprises 8, 9, 10, 11, 12, 13, 14, 15, 16, 17, 18, 19, 20 or more of the holes.

[52] The seal of [51], wherein the holes are aligned circumferentially around the ring and are about equidistant from each other.

[53] The seal of any one of [50] to [52], wherein each of the at least one channels individually comprises: (i) a first port on a surface of the bore of the ring, (ii) a second port at the outer circumference of the ring, and (iii) a passageway therebetween through the ring.

[54] The seal of [53], wherein the ring comprises a groove extending around a wall of the ring defining the bore, wherein the first port of each of the at least one channels is within the groove.

[55] The seal of any one of [50] to [54], wherein, in cross-section, a portion of the ring most proximal to the bore is a trapezoid shape with each parallel side being a base, the shorter base defining the bore of the ring and the larger base being of greater width than the remainder of the ring that extends outwardly therefrom.

[56] The seal of [55], wherein non-parallel sides of the trapezoid have a jagged edge.

[57] The seal of any one of [50] to [56], wherein the expandable material forms a shoulder on each side of the seal.

[58] The seal of [57], wherein the shoulder comprises a shoulder spring.

[59] The seal of any one of [50] to [58], further comprising a circular seal spring within the seal ring that is in co-axial arrangement with the seal ring.

[60] A line-stopping tool for plugging a pipe, the line-stopping tool comprising: a head unit configured for location in a section of a pipe, the head unit comprising at least one seal configured to engage the wall of the pipe to plug the section of the pipe, wherein the at least one seal comprises: (i) a ring defining a bore and having a width and a thickness, the ring having one or more holes spanning the width and open to both a first and second side of the ring; (ii) at least one channel configured for providing fluid communication between the bore of the ring and an exterior surface of the ring outside the bore; and (iii) an expandable material covering at least the surfaces of the ring outside the bore, the expandable material forming a seal ring extending around and outwardly from an outer circumference of the ring; a carrier unit having a pivotal connection to the head unit; and a fluid conduit in fluid communication with one or more of the at least one channels, and configured for providing an expansion medium to the at least one seal.

The foregoing description is only exemplary of the principles of seals 10, line-stopping tools 50 and methods of the present disclosure. Many modifications and variations are possible in light of the above teachings. The preferred embodiments of the present disclosure have been disclosed, however, so that one of ordinary skill in the art would recognize that certain modifications would come within the scope of this disclosure and may be advantageous.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

It must be noted that as used in this specification and the appended claims, the singular forms “a”, “an”, and “the” include plural reference unless the context clearly dictates otherwise. Unless defined otherwise all technical terms used herein have the same meaning as commonly understood to one of ordinary skill in the art to which this invention belongs.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to encompass the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

As used herein, whether in the specification or the appended claims, the transitional terms “comprising”, “including”, “having”, “containing”, “involving”, and the like are to be understood as being inclusive or open-ended (i.e., to mean including but not limited to), and they do not exclude unrecited elements, materials or method steps. Only the transitional phrases “consisting of” and “consisting essentially of”, respectively, are closed or semi-closed transitional phrases with respect to claims and exemplary embodiments herein. The transitional phrase “consisting of” excludes any element, step, or ingredient which is not specifically recited. The transitional phrase “consisting essentially of” limits the scope to the specified elements, materials or steps and to those that do not materially affect the basic characteristic(s) of the invention disclosed and/or claimed herein.

1. A seal for a line-stopping tool, the seal comprising:
an inner ring disposed within an outer ring in a coaxial arrangement and defining an annular space therebetween;
at least one bridge member spanning the annular space and connecting the inner ring to the outer ring;
at least one channel configured for providing fluid communication between a bore defined by the inner ring and an exterior surface of the outer ring; and
an expandable material surrounding the outer ring and forming a seal ring extending around and outwardly from an outer circumference of the outer ring.

2. The seal of claim 1, wherein the expandable material fills the annular space and covers each of the at least one bridge members and the inner ring outside the bore.

3. The seal of claim 1, wherein the expandable material forms:
(i) a lip extending longitudinally outward from each side of the inner ring, each lip encircling and further defining the bore; and/or
(ii) a shoulder on each side of the seal, the shoulder optionally comprising a shoulder spring.

4. The seal of claim 1, wherein the seal ring is concentric with the inner ring and the outer ring and in radial cross-section the expandable material extending around and outwardly from the outer circumference of the outer ring is thicker than the expandable material on each side of the outer ring.

5. The seal of claim 1, wherein the at least one bridge member is 2, 3 or 4 bridge members and the bridges members are equidistant from each other in the annular space.

6. The seal of claim 1, wherein each of the at least one channels individually comprises: (i) a first port on a surface of the bore of the inner ring, (ii) a second port on the exterior surface of the outer ring, and (iii) a passageway therebetween through the inner ring, one of the at least one bridge members, and the outer ring.

7. The seal of claim 6, wherein the inner ring comprises a groove extending around a wall of the inner ring defining the bore, wherein the first port of each of the at least one channels is within the groove.

8. The seal of claim 1, further comprising a circular seal spring within the seal ring that is in co-axial arrangement with the seal ring.

9. The seal of claim 1, wherein, when an expansion medium is provided to the exterior surface of the outer ring via one or more of the at least one channels, the expandable material expands from a retracted position to an expanded position.

10. A line-stopping tool for plugging a pipe, the line-stopping tool comprising:
a head unit configured for location in a section of a pipe, the head unit comprising at least one seal configured to engage the wall of the pipe to plug the section of the pipe, wherein the at least one seal comprises:
(i) an inner ring disposed within an outer ring in a coaxial arrangement and defining an annular space therebetween;
(ii) at least one bridge member spanning the annular space and connecting the inner ring to the outer ring;
(iii) at least one channel configured for providing fluid communication between a bore defined by the inner ring and an exterior surface of the outer ring; and
(iv) an expandable material surrounding the outer ring and forming a seal ring extending around and outwardly from an outer circumference of the outer ring;
a carrier unit having a pivotal connection to the head unit; and
a fluid conduit in fluid communication with one or more of the at least one channels, and configured for providing an expansion medium to the at least one seal.

11. The line-stopping tool of claim 10, wherein the head unit comprises two of the at least one seals.

12. The line-stopping tool of claim 11, wherein the fluid conduit comprises:
a first fluid conduit configured for providing the expansion medium to the at least one channel of a first seal of the two seals; and
a second fluid conduit configured for providing the expansion medium to the at least one channel of a second seal of the two seals.

13. The line-stopping tool of claim 12, wherein the first fluid conduit and the second fluid conduit are in fluid communication with the at least one channel of the first and second seals, respectively, via a groove extending around a wall of the inner ring defining the bore of each seal.

14. The line-stopping tool of claim 10, wherein the head unit comprises an arm assembly and a head assembly with the at least one seal being on the head assembly, the arm assembly having a smaller girth than the head assembly for pivotal location of the head assembly in the pipe, and the arm assembly comprising a knuckle configured to abut against the wall at a bottom of the pipe and center the head assembly within the pipe when the line-stopping tool is positioned within the pipe.

15. The line-stopping tool of claim 10, wherein, when the line-stopping tool is positioned within the pipe and when expansion medium is provided to each seal of the at least one seal, the expandable material expands from a retracted position to an expanded position to engage the wall of the pipe.

16. A method of isolating a section of a pipe, the method comprising the steps of:
inserting a head unit into a pipe, the head unit comprising at least one seal configured to engage the wall of the pipe, wherein the at least one seal comprises:
(i) an inner ring disposed within an outer ring in a coaxial arrangement and defining an annular space therebetween;
(ii) at least one bridge member spanning the annular space and connecting the inner ring to the outer ring;
(iii) at least one channel configured for providing fluid communication between a bore defined by the inner ring and an exterior surface of the outer ring; and
(iv) an expandable material surrounding the outer ring and forming a seal ring extending around and outwardly from an outer circumference of the outer ring, and
providing an expansion medium to the at least one seal via a fluid conduit in fluid communication with the at least one channel of the at least one seal, to sealingly engage the at least one seal against the pipe and thereby isolate a section of the pipe.

17. The method of claim 16, wherein the head unit comprises two of the at least one seals.

18. The method of claim 17, further comprising a step of pressurizing an interior space of the pipe located between the two seals via a pressurization conduit in fluid communication with a pressurization port located at an external surface of the head unit and open to the interior space.

19. The method of claim 16, wherein the step of providing the expansion medium to the at least one seal is repeated, independently for each seal, at any time to maintain sealing engagement against the wall of the pipe.

20. A seal for a line-stopping tool, the seal comprising:
a ring defining a bore and having a width and a thickness, the ring having one or more holes spanning the width and open to both a first and second side of the ring;
at least one channel configured for providing fluid communication between the bore of the ring and an exterior surface of the ring outside the bore; and
an expandable material covering at least the surfaces of the ring outside the bore, the expandable material forming a seal ring extending around and outwardly from an outer circumference of the ring.

21. The seal of claim 20, which comprises 8, 9, 10, 11, 12, 13, 14, 15, 16, 17, 18, 19, 20 or more of the holes.

22. The seal of claim 21, wherein the holes are aligned circumferentially around the ring and are about equidistant from each other.

23. The seal of claim 20, wherein each of the at least one channels individually comprises: (i) a first port on a surface of the bore of the ring, (ii) a second port at the outer circumference of the ring, and (iii) a passageway therebetween through the ring.

24. The seal of claim 23, wherein the ring comprises a groove extending around a wall of the ring defining the bore, wherein the first port of each of the at least one channels is within the groove.

25. The seal of claim 20, further comprising a circular seal spring within the seal ring that is in co-axial arrangement with the seal ring.

26. A line-stopping tool for plugging a pipe, the line-stopping tool comprising:
a head unit configured for location in a section of a pipe, the head unit comprising at least one seal configured to engage the wall of the pipe to plug the section of the pipe, wherein the at least one seal comprises:
(i) a ring defining a bore and having a width and a thickness, the ring having one or more holes spanning the width and open to both a first and second side of the ring;
(ii) at least one channel configured for providing fluid communication between the bore of the ring and an exterior surface of the ring outside the bore; and
(iii) an expandable material covering at least the surfaces of the ring outside the bore, the expandable material forming a seal ring extending around and outwardly from an outer circumference of the ring;
a carrier unit having a pivotal connection to the head unit; and
a fluid conduit in fluid communication with one or more of the at least one channels, and configured for providing an expansion medium to the at least one seal.
